(19) United States
(12) Patent Application Publication
(10) Pub. No.: US 2026/0110381 A1
(43) Pub. Date: Apr. 23, 2026

(54) WIDE RANGE GLAND FOR MECHANICAL JOINT

(71) Applicants: Ryan Fairchild Larson, Decatur, IL (US); David Latimore Hughes, JR., Signal Mountain, TN (US)

(72) Inventors: Ryan Fairchild Larson, Decatur, IL (US); David Latimore Hughes, JR., Signal Mountain, TN (US)

(21) Appl. No.: 18/922,536

(22) Filed: Oct. 22, 2024

(51) Int. Cl. F16L 37/092

(52) U.S. Cl. CPC F16L 37/0927; F16L 37/0925

(57) ABSTRACT

A gland for mechanically joining and sealing a piping element to a mechanical joint can include an end ring, at least one gripper contacting the end ring and arranged to contact the piping element in gripping arrangement, and at least one gasket arranged to seal the mechanical joint and the piping element.

### TECHNICAL FIELD

This disclosure relates to water control products. More specifically, this disclosure relates to joints within water control systems.

### BACKGROUND

In the field of piping systems, mechanical joints for piping elements such as valves can be common amongst varying piping sizes. Mechanical joints for such piping systems can be sized to accept piping elements of varying sizes. When joining piping elements such as pipes into such mechanical joints, the glands used to make such connections can be required to be precise in sizing. This can become a challenge in field applications where varying piping materials are of varying actual sizes even if such pipes are nominally the same size. For example, ductile iron pipes that are termed “six inch pipes” are of a different measured diameter from steel pipes that are termed “six inch pipes.” A gland that can couple the standard sized mechanical joints to varying pipe sizes—and varying materials—is currently not available in the field.

### SUMMARY

It is to be understood that this summary is not an extensive overview of the disclosure. This summary is exemplary and not restrictive and is intended to neither identify key or critical elements of the disclosure nor delineate the scope thereof. The sole purpose of this summary is to explain and exemplify certain concepts of the disclosure as an introduction to the following complete and extensive detailed description.

In one aspect of the current disclosure, a gland can include an end ring, at least one gripper that can contact the end ring, and at least one gasket that can contact the gripper.

In another aspect of the current disclosure, a gland for attaching a piping element to a mechanical joint can include an end ring, the end ring can define a main cavity sized to accept the piping element; a gripper, the gripper can define a main cavity sized to accept the piping element; the gripper can abut the end ring, the gripper can include a plurality of gripping teeth that can be arranged to contact the piping element; a gasket that can be arranged around the piping element and can be configured to receive compressive forces in response to motion of the end ring; and, at least one fastener that can connect the end ring to the mechanical joint in a tightening arrangement, wherein the gasket can be in contact with the mechanical joint and with the piping element in an arrangement that can provide a fluid seal between the mechanical joint and the piping element.

In another aspect of the current disclosure, a method of connecting a gland to a mechanical joint to secure a piping element within the mechanical joint can include obtaining a gland assembly, wherein the gland assembly can include an end ring; at least one fastener; at least one gasket; and at least one gripper, each gripper can include at least one gripping tooth; arranging the end ring, the gripper, and the gasket surrounding the piping element, the end ring can contact at least one of the gripper and the gasket, the gripper can contact at least one of the end ring and the gasket; arranging the piping element within an opening of the mechanical joint; arranging the at least one fastener in coupling engagement with the end ring and the mechanical joint; and tightening the at least one fastener such that the at least one gripping tooth can contact the piping element.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, explain various principles of the disclosure. The drawings are not necessarily drawn to scale. Corresponding features and components throughout the figures may be designated by matching reference characters for the sake of consistency and clarity.

FIG. 1 is a top side perspective view of a gland assembled to a mechanical joint of a valve in accordance with one aspect of the current disclosure.

FIG. 2 is side perspective view of a valve body of the valve of FIG. 1.

FIG. 3 is a side cross sectional view of the gland of FIG. 1 taken along the section indicated by line 11-11 shown in FIG. 1.

FIG. 4 is a front side view of a gripper of the gland of FIG. 1.

FIG. 5 is a front side perspective view of the gripper of FIG. 4.

FIG. 6 is a perspective cross-sectional view of the gripper of FIG. 4 taken along the section indicated by line 6-6 of FIG. 4.

FIG. 7 is side perspective view of an end ring of the gland of FIG. 1.

FIG. 8 is a side cross-sectional view of the end ring of FIG. 7 taken along the section indicated by line 8-8 in FIG. 7.

FIG. 9 is a rear perspective view of the end ring of FIG. 7.

FIG. 10 is a perspective view of a washer of the gland of FIG. 1.

FIG. 11 is a perspective view of a gasket of the gland of FIG. 1.

FIG. 12 is a perspective cross-sectional view of the gasket of FIG. 11 taken along the section indicated by line 12-12 in FIG. 11.

FIG. 13 is a detail view of the gland of FIG. 1 in an untightened arrangement viewed in the area indicated by detail 13 in FIG. 3.

FIG. 14 is a detail view of the gland of FIG. 1 viewed in the area indicated by detail 14 in FIG. 13.

FIG. 15 is a detail view of the gland of FIG. 1 as presented in the detail view of FIG. 13 with the gland in a tightened arrangement.

FIG. 16 is a detail view of the gland of FIG. 1 viewed in the area indicated by detail 16 in FIG. 15.

FIG. 17 is a side perspective view of another aspect of a gasket for use with the gland of FIG. 1 in accord with one aspect of the current disclosure.

FIG. 18 is a perspective cross-sectional view of the gasket of FIG. 17 taken along the section indicated by line 18-18 in FIG. 17.

FIG. 19 is a perspective cross-sectional view of the gland of FIG. 1 including the gasket of FIG. 17 in the tightened arrangement as presented in FIG. 15 in accord with another aspect of the current disclosure.

FIG. 20 is a top perspective view of another aspect of a gripper for use with the gland of FIG. 1 in accord with another aspect of the current disclosure.

FIG. 21 is a side cross-sectional view of the gland of FIG. 1 including the gripper of FIG. 20 in accord with another aspect of the current disclosure.

FIG. 22 is a top side perspective view of another aspect of a gripper for use with the gland of FIG. 1 in accord with another aspect of the current disclosure.

FIG. 23 is a side perspective view of another aspect of a gripper for use with the gland of FIG. 1 in accord with another aspect of the current disclosure.

FIG. 24 is a detail perspective view of a grip segment of the gripper of FIG. 23.

FIG. 25 is a side cross-sectional view of the gland of FIG. 1 including the gripper of FIG. 23 in accord with another aspect of the current disclosure.

FIG. 26 is a side perspective view of another aspect of a gasket for use with the gland of FIG. 1 in accord with one aspect of the current disclosure.

FIG. 27 is a perspective cross-sectional view of the gasket of FIG. 26 taken along the section indicated by line 27-27 in FIG. 26.

FIG. 28 is a perspective view of a grip segment for use with the gasket of FIG. 26 in accord with another aspect of the current disclosure.

FIG. 29 is a side cross-sectional view of the gland of FIG. 1 including a plurality of the grip segments of FIG. 28 with the gasket of FIG. 26 in accord with another aspect of the current disclosure.

FIG. 30 is a perspective view of a tear-out gasket for use with the gland of FIG. 1 in accord with another aspect of the current disclosure.

FIG. 31 is a perspective view of another tear-out gasket for use with the gland of FIG. 1 in accord with another aspect of the current disclosure.

FIG. 32 is a side cross-sectional view of a gland in accord with another aspect of the current disclosure.

FIG. 33 is a detail view of the gland of FIG. 32 viewed in the area indicated by detail 33.

FIG. 34 is a detail view of the gland of FIG. 32 viewed in the area indicated by detail 34.

FIG. 35 is a detail view of a gland in accord with another aspect of the current disclosure.

FIG. 36 is a perspective view of a retention ring of the gland of FIG. 35.

FIG. 37 is a perspective view of a gasket of the gland of FIG. 35.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget”is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance may or may not occur and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams. Unless otherwise specified herein, any structure disclosed in the drawings or in the written description as being so formed can be monolithic whether or not such an explicit description of the structure is included herein.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of a break check valve nearest to an outlet of the valve, and “rear” is the end of the break check valve which can be opposite or distal the front. “Horizontal” or “horizontal orientation” describes that which is in a plane extending from left to right and aligned with the horizon. “Vertical” or “vertical orientation” describes that which is in a plane which can be angled at 90 degrees to the horizontal.

Disclosed is a gland along with associated methods, systems, devices, and various apparatus. It would be understood by one of skill in the art that the disclosed gland is described in but a few exemplary embodiments among many. No particular terminology or description should be considered limiting on the disclosure or the scope of any claims issuing therefrom.

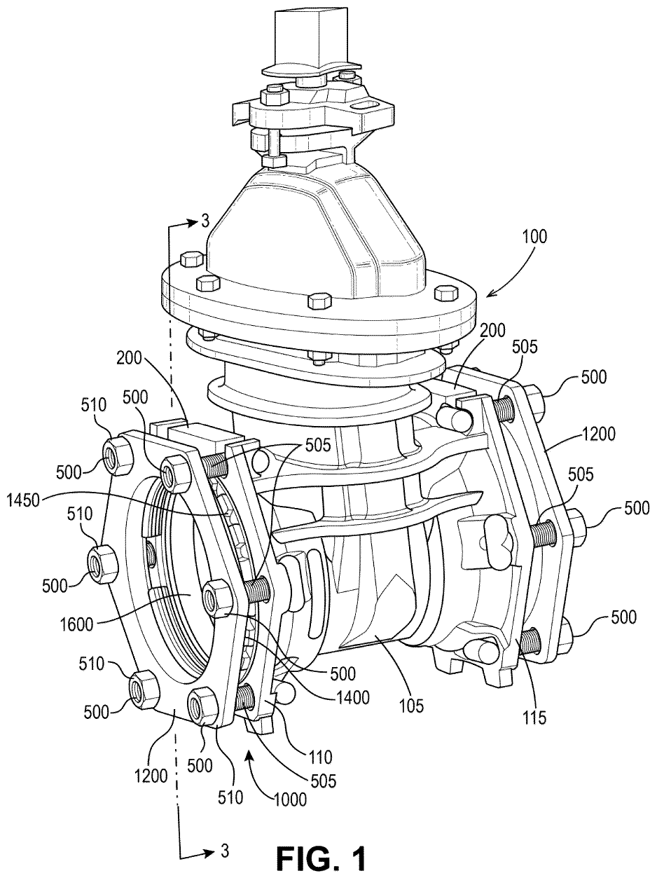

One embodiment of a gland 1000 is disclosed and described in FIG. 1. The gland 1000 can be a gland assembly 1000 in various aspects of the disclosure. The gland 1000 can be a gland kit 1000 in various aspects of the disclosure. One of skill in the art would understand that any particular configuration of the current disclosure is provided for exemplary purposes and is not intended to limit the scope of any claims issuing therefrom.

A valve 100 can be seen in the view of FIG. 1. The valve 100 can be any type of water control product including joints, intersections, valves, metering apparatus, hydrants, hydrant shoes, and various other products known in the art. In the current aspect, the valve 100 is a gate valve. The valve 100 can include a valve body 105. In various aspects, the valve body 105 can be formed of various materials including steel, iron, ductile iron, brass, or various other materials known in the art. Various valves such as the valve 100 can comprise additional elements not shown in the current view, such as a gate, a bonnet, and various fasteners.

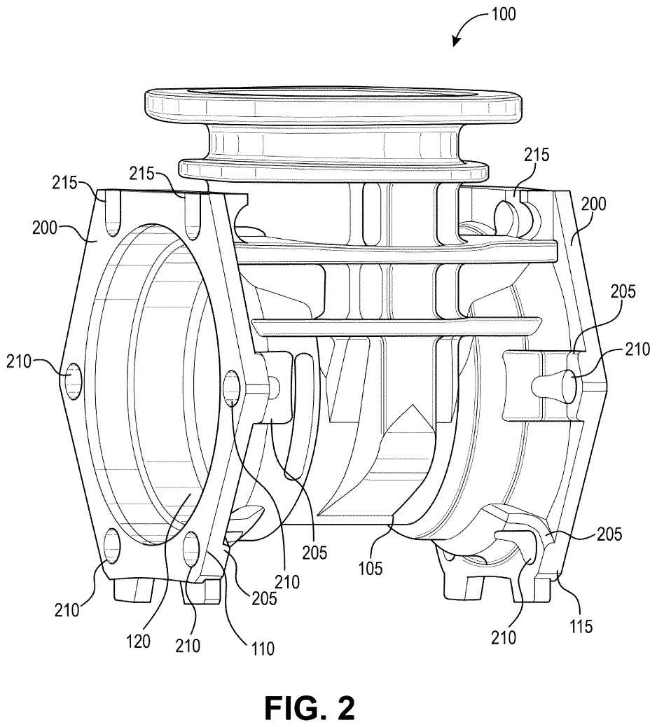

With reference to FIGS. 1-2, the valve body 105 can define a first end 110 and a second end 115. The valve body 105 can define a chamber 120. The chamber 120 can be a fluid gateway that can allow the first end 110 to be in fluid communication with the second end 115 when the gate is opened. In current aspect, the valve body 105 can be about symmetrical in that the first end 110 can be about the same as the second end 115 in size and shape. In various aspects, the valve body 105 can be asymmetrical.

Each end 110,115 of the valve body 105 can define a mechanical joint 200. Each mechanical joint 200 can be about hexagonal in shape and can define a plurality of lugs 205 located proximal to each point of the hexagonal shape. A plurality of the lugs 205 can define a bolt hole 210. Lugs 205 proximate a top of the mechanical joint 200 can define bolt pathways 215. In various aspects, all lugs 205 can define bolt holes 210. In various aspects, all lugs 205 can define bolt pathways 215. In various aspects, the bolt holes 210 and bolt pathways 215 can be arranged to receive fasteners to the mechanical joint 200 to allow additional water control elements to become coupled to the valve body 105.

With returning reference to FIG. 1, the gland 1000 can be one such water control element to be coupled to the valve 100 along the mechanical joint 200. The gland 1000 can comprise an end ring 1200 that can be generally shaped in a similar hexagonal arrangement as the mechanical joint 200. The gland 1000 can comprise a gripper 1400. In the current aspect, the gripper 1400 can be a grip ring 1450. The grip ring 1450 can define a main cavity 1451. In various aspects, various arrangements of grippers 1400 can be utilized as will be discussed in greater detail elsewhere in this disclosure. In assembly, the grip ring 1450 can be arranged between the end ring 1200 and the mechanical joint 200. The gland 1000 can comprise at least one gasket 1600 arranged proximate the mechanical joint 200 of the valve body 105. The gasket 1600 can be a gasket assembly in various aspects and can comprise multiple gaskets in various aspects. A flat washer 1800 can be arranged between the grip ring 1450 and the gasket 1600. A plurality of fasteners 500 can be arranged within the bolt holes 210 and bolt pathways 215. Each fastener 500 can comprise a bolt 505 and a nut 510. In the current aspect, each bolt 505 can be a tee bolt and each nut 510 can be a hex nut, although various aspects can comprise various shapes and arrangements of fasteners known in the art.

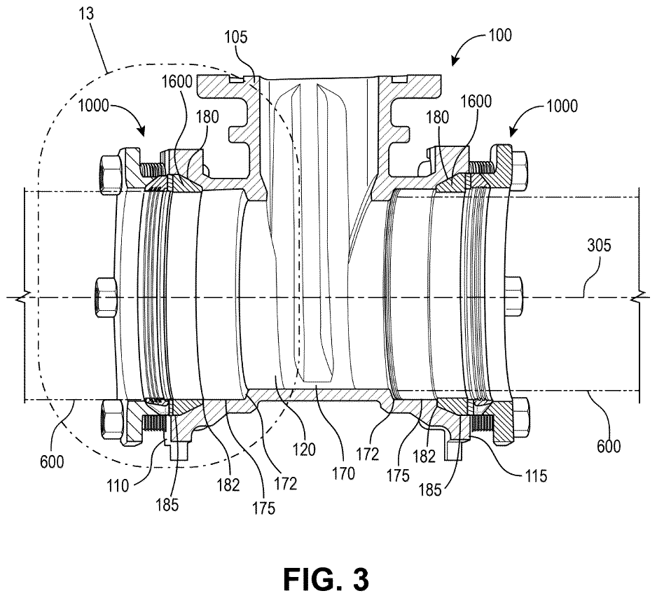

As seen with reference to FIG. 3, a piping element 600 can be placed within the chamber 120 of the valve body 105. Each piping element 600 can be a pipe as part of a piping system or plumbing system as would be understood by one of skill in the art. The piping system can be a municipal piping system. In various aspects, additional piping elements can be utilized without departing from the scope of the current disclosure. The chamber 120 of the valve body 105 can comprise a central chamber 170 that can be of a width or a diameter that can match the diameter of the piping system. In various aspects, the chamber 120 can be generally tubular with varying diameters. An axis 305 of the valve body 105 can be seen. The axis 305 can also serve as an axis of each piping element 600.

The central chamber 170 can connect to a piping chamber 175 that can be a portion of the chamber 120. The piping chamber 175 can be sized to receive and to accommodate the piping element 600. The piping chamber 175 can be of a larger diameter than the central chamber 120. The chamber 120 can transition from the central chamber 170 to the piping chamber 175 by an inner face 172. The piping chamber 175 can connect to a gasket chamber 180 that can be sized to receive and to accommodate the gasket 1600. For reference, the mechanical joint 200 can be understood by one of skill in the art to terminate at the termination of the inner face 172.

The central chamber 170 can be about in the center of the valve body 105 and can define an innermost portion of the valve body 105 as measured axially along the axis 305. Each end 110,115 can define an outermost portion of the valve body 105 as measured axially along the axis 305. The gasket chamber 180 can comprise a slope such that the gasket chamber 180 can define a frustoconical profile with its smallest diameter axially inward and its largest diameter axially outward as measured along the axis 305. Such arrangement can allow the gasket 1600 to be compressed against the piping element 600 in assembly. The gasket 1600 can be compressed in various aspects. The gasket 1600 can be deformed in response to compression forces in various aspects. The piping chamber 175 can transition to the gasket chamber 180 at a gasket chamber face 182. The gasket chamber face 182 can be about flat as measured in the axial direction along the axis 305. The gasket chamber face 182 can provide a mechanical stopping point for the gasket 1600 in assembly. In various aspects, the gasket chamber face 182 can comprise chamfers, fillets, or other features to encourage behavior of the gasket 1600. An entrance portion 185 can be arranged adjacent to the gasket chamber 180. The entrance portion 185 can be about cylindrical in inner diameter and can match the largest inner diameter of the gasket chamber 180. Such features can further compress the gasket 1600 in various aspects. In various aspects, additional features can manipulate the sealing of the gasket 1600. Various features can manipulate the positioning of the gasket 1600 within the gland 1000.

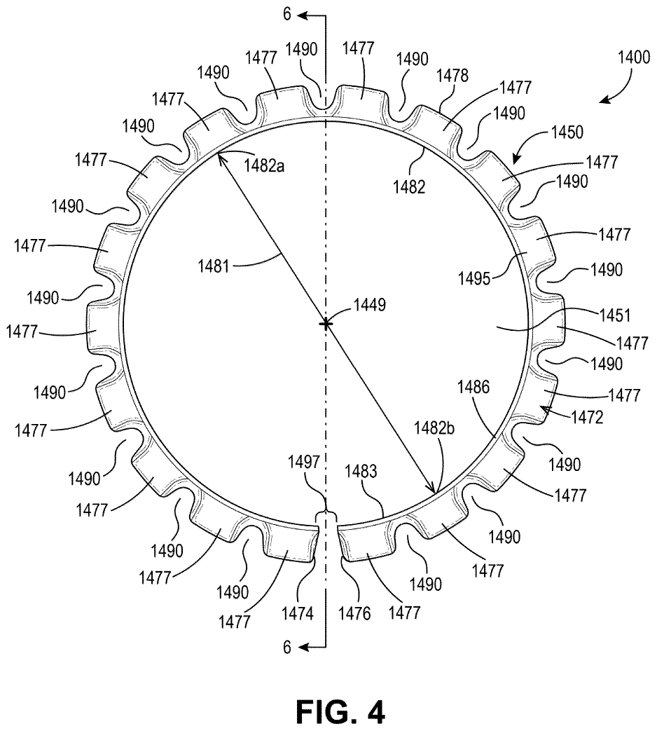

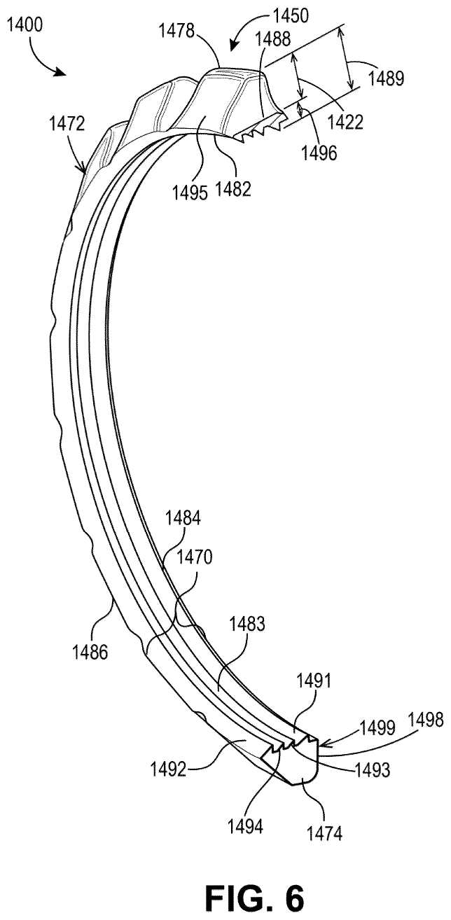

The grip ring 1450 can be seen with reference to FIGS. 4-6. The grip ring 1450 can be one aspect of the gripper 1400. The grip ring 1450 can be annular in various aspects. The grip ring 1450 can be C-shaped in various aspects. The grip ring 1450 can comprise a substantially ring-shaped body 1472. The grip ring 1450 can define a first body end 1474 and a second body end 1476 in proximity with one another. The first body end 1474 can be termed a “first circumferential end” and the second body end 1476 can be termed a “second circumferential end” in various aspects. The grip ring 1450 can comprise a radially outward end 1478 and a radially inward end 1482. The radially inward end 1482 can define a contact surface 1483. The radial ends 1478,1482 can be termed “inward” and “outward” based on a center 1449 of the grip ring 1450 being referenced as being inward. The center 1449 can be located at an axis 1459 of the grip ring 1450. An inner diameter 1481 of the grip ring 1450 can be measured linearly through the center 1449 of the grip ring 1450 from the radially inward end 1482 annotated by 1482a to the radially inward end 1482 annotated by 1482b.

The grip ring 1450 can also define an axially inward end 1484 and an axially outward end 1486. The axial ends 1484,1486 can be termed as “inward” and “outward” in reference to the gland 1000 when connected to the mechanical joint 200. The radially inward end 1482 of the grip ring 1450 can comprise a plurality of gripping teeth 1470. In the current aspect, the gripping teeth 1470 can be biased. In the current aspect, the gripping teeth 1470 can be biased toward the axially inward end 1484 such that the gripping teeth 1470 can point more towards the axially inward end 1484 than toward the axially outward end 1486. In various aspects, the gripping teeth 1470 can be of various sizes. In various aspects, the griping teeth 1470 can be of uniform size. In various aspects, the gripping teeth 1470 can point neutrally or can be biased in various other directions.

In the current aspect, the plurality of gripping teeth 1470 can comprise a first large tooth 1491 and a second large tooth 1492. In the current aspect, the first large tooth 1491 can be arranged circumferentially encompassing the axially inward end 1484 of the contact surface 1483. The second large tooth 1492 can be arranged circumferentially encompassing the axially outward end 1486 of the contact surface 1483. A first small tooth 1493 and a second small tooth 1494 can be arranged on the contact surface 1483 between the first large tooth 1491 and the second large tooth 1492. In the current aspect, the first small tooth 1493 can be proximate the first large tooth 1491 and the second small tooth 1494 can be proximate the second large tooth 1492. In various aspects, various arrangements of gripping teeth 1470 can be utilized without departing from the scope of the current disclosure.

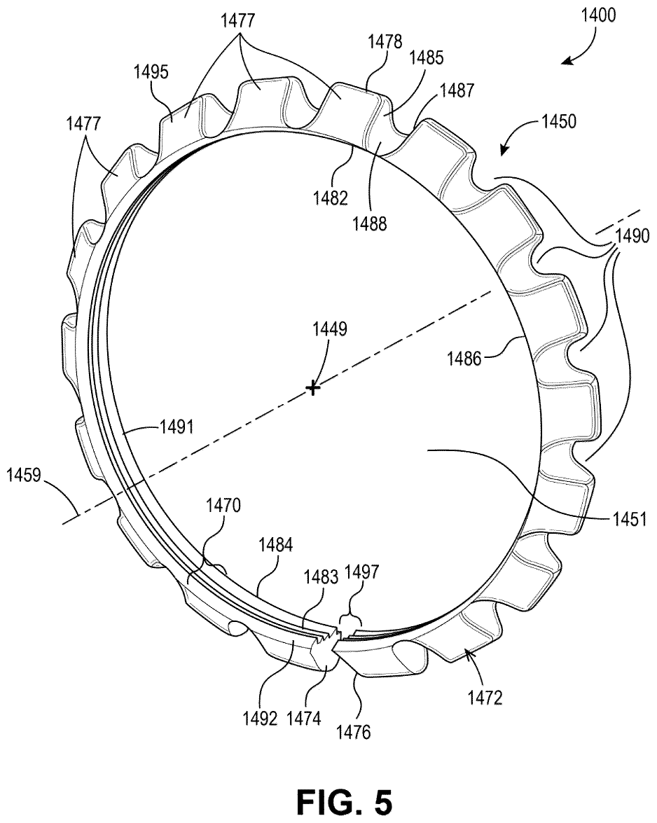

The body 1472 can define a plurality of relief notches 1490. Each relief notch 1490 can be defined in the body 1472 in spaced arrangement being spaced about equal distance apart. In the current aspect, each of the relief notches 1490 can be equally spaced apart. In various aspects, various relief notches 1490 can be spaced at various intervals. In the current aspect, the grip ring 1450 can define seventeen relief notches 1490. In various aspects, more or fewer relief notches 1490 can be utilized depending on the and application and desired material of the body 1472 of the grip ring 1450. The relief notches 1490 can define a physical separation of portions of the body 1472. As such, a plurality of segmented body portions 1477 can define ends 1485,1487 (seen with specific reference to FIG. 5) of the relief notches 1490 such that the relief notches 1490 can be defined between two segmented body portions 1477. A bottom 1488 of each of the relief notches 1490 can be defined between two segmented body portions 1477 adjacent to each of the relief notches 1490. In the current aspect, the relief notches 1490 can be arranged on an outside of the grip ring 1450. In various aspects, the relief notches 1490 can be arranged on an inside of the grip ring 1450.

In the current aspect, a body thickness 1489 can be defined as a linearly measured distance along a radial direction from the radially inward end 1482 of the grip ring 1450 to the nearest radially outward end 1478 as measured along one of the segmented body portions 1477. Such body thickness 1489 can define a height of a back 1498 of the grip ring 1450. Similarly, a relief thickness 1496 can be defined as the maximum thickness of the grip ring 1450 at the bottom 1488 of each of the relief notches 1490. A relief notch depth 1422 of each relief notch 1490 can be measured as the difference between the body thickness 1489 and the relief thickness 1496. In other words, the relief notch depth 1422 can measure how deep into the body 1472 each relief notch 1490 can extend from the radially outward end 1478 of the grip ring 1450.

In various aspects, the relief thickness 1496 can be of various sizes. In various aspects, the relief thickness 1496 can be under one inch. In various aspects, the relief thickness 1496 can be under one-half inches. In various aspects, the relief thickness 1496 can be under 0.25 inches. In various aspects, the relief thickness 1496 can be under 0.20 inches. In the current aspect, the relief thickness 1496 can be about 0.17 inches.

In various aspects, the relief notch depth 1422 can be greater than 50% of the body thickness 1489. In various aspects, the relief notch depth 1422 can be greater than 60% of the body thickness 1489. In various aspects, the relief notch depth 1422 can be greater than 70% of the body thickness 1489. In various aspects, the relief notch depth 1422 can be greater than 80% of the body thickness 1489. In various aspects, the relief notch depth 1422 can be between 60% and 70% of the body thickness 1489. In various aspects, the relief notch depth 1422 can be between 65% and 70% of the body thickness 1489. In the current aspect, by way of nonlimiting example, the relief notch depth 1422 can be about 68% of the body thickness 1489.

The body 1472 can comprise a sloped compression surface 1495 at each of the segmented body portions 1477. The sloped compression surface 1495 can be arranged on the radially outward end 1478 proximate the axially outward end 1486 and can slope in a substantially conical direction. In various aspects, the sloped compression surface 1495 can define a substantially truncated cone and can be generally frustoconical. The compression surface 1495 can be arranged to interact with the end ring 1200 during assembly.

The grip ring 1450 can define a gap 1497 between the first body end 1474 and the second body end 1476. The grip ring 1450 can deform during assembly, allowing the first body end 1474 to travel toward the second body end 1476 thereby reducing the gap 1497. In various aspects, the material of the grip ring 1450 can allow flexure such that the grip ring 1450 can be of flexed during assembly. In various aspects, the grip ring 1450 can be metallic. The relief notches 1490 can allow the metallic grip ring 1450 to flex during assembly, thereby allowing the first body end 1474 to travel toward the second body end 1476 without damaging the grip ring 1450 or requiring inordinate amounts of force. In various aspects, the relief notch depth 1422 can be impacted by the material choices to form the grip ring 1450 and the desired amount of flexion of the grip ring 1450. The relief notches 1490 can be of variant size or shape depending on the material chosen for the grip ring 1450. In various aspects, the grip ring 1450 can be various metals including steel, iron, stainless steel, ductile iron, cast iron, and brass, among others. In various aspects, other materials are contemplated and within the scope of the disclosure. In the current aspect, by way of nonlimiting example, the grip ring 1450 can be ductile iron. In various aspects, the grip ring 1450 can be stainless steel. In various aspects, the grip ring 1450 can be 400 series stainless steel, including 410 stainless steel or 420 stainless steel as would be understood by one of skill in the art.

The grip ring 1450 can comprise a gasket interaction surface 1499. The gasket interaction surface 1499 can be arranged on and partially defining the axially inward end 1484 on the radially outward end 1478 of the grip ring 1450. In various aspects, the gasket interaction surface 1499 can be sloped. In the current aspect, the gasket interaction surface 1499 can be defined of minimal slope, extreme slope, or no slope. Various profiles of the gasket interaction surface 1499 can influence how the gasket 1600 interacts with the grip ring 1450.

The body thickness 1489 can also define a thickness of the back 1498. In various aspects, the body thickness 1489 can be sufficiently large such that the back 1498 can be of additional height. In wide range applications, the grip ring 1450 can experience significant flexion. When interacting with the end ring 1200, additional height of the back 1498 can prevent the grip ring 1450 from slipping out of the end ring 1200. The additional body thickness 1489 can be needed in various applications to prevent the grip ring 1450 from slipping out of the end ring 1200. In such applications, relief notches 1490 can be important to allow for materials of the grip ring 1450 to be utilized that otherwise might not be able to flex sufficiently at large body thickness 1489. Additionally, the relief notch depth 1422 can be of importance depending on the material chosen. In the current aspect, the relief notch depth 1422 at 68% of the body thickness 1489 can be of importance.

In various aspects, the relief thickness 1496 can be limiting to the flexion of the grip ring 1450. By way of nonlimiting example, in various aspects, a relief thickness 1496 of up to 0.25 inches can be applicable to ductile iron material regardless of the size of the body thickness 1489. For different materials, different relief thicknesses 1496 can be variously imposed without departing from the scope of the current disclosure.

The grip ring 1450 can provide advantages over some other methods of a gripping apparatus to function as gripper 1400. The grip ring 1450 can be cost-effective to produce. In various aspects, the grip ring 1450 can be cast ductile iron, meaning that the grip ring 1450 can be a single part in various aspects. In various aspects, multiple parts can be utilized to form the grip ring 1450 without departing from the scope of the disclosure.

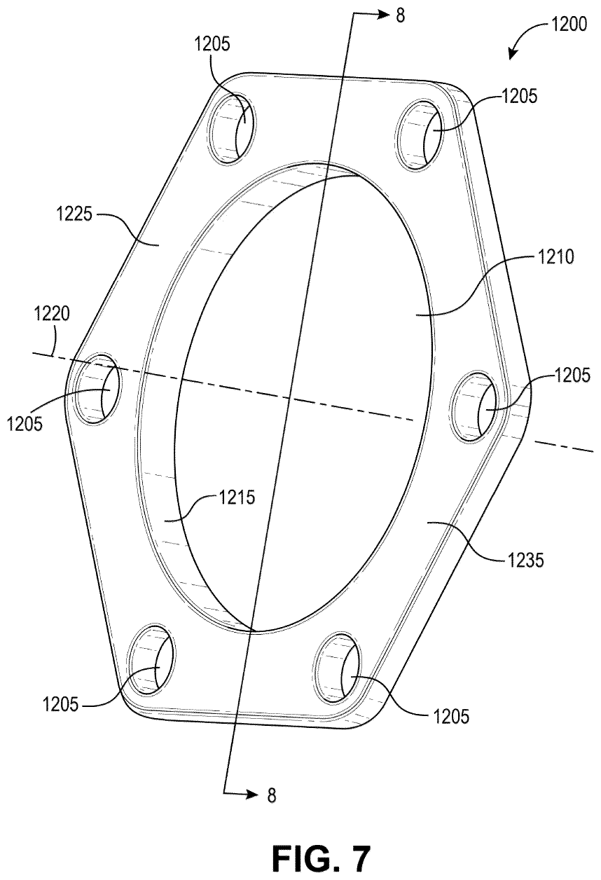

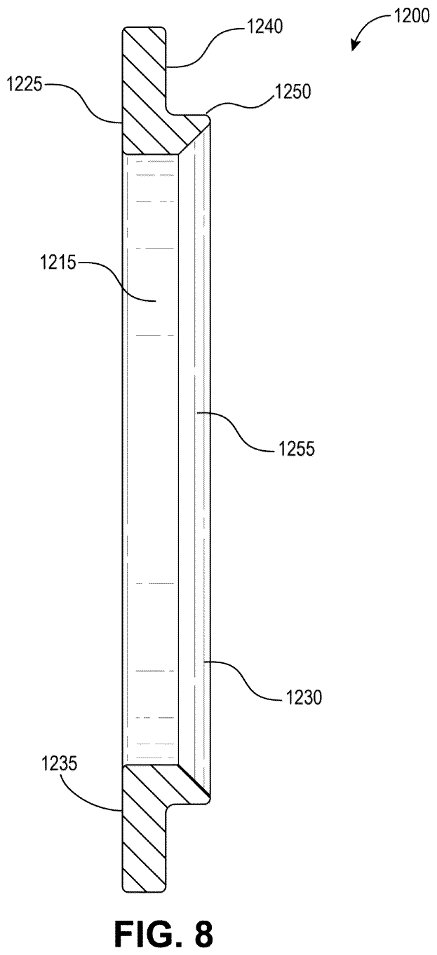

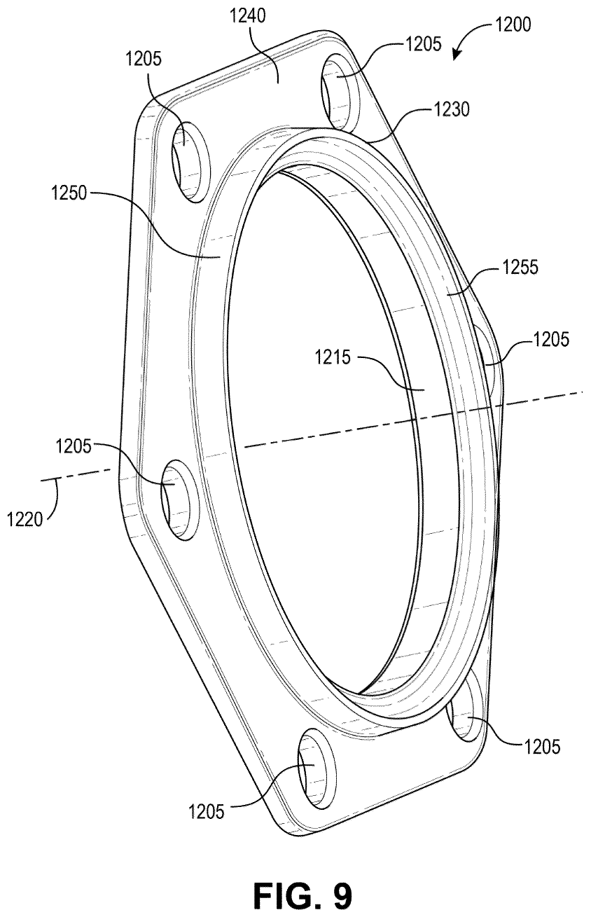

The end ring 1200 can be seen with reference to FIGS. 7-9. The end ring 1200 can comprise a main body defining a shape roughly to match the shape of the mechanical joint 200. In the current aspect, the end ring 1200 can be about hexagonal in shape. The end ring 1200 can define a plurality of bolt holes 1205 about a perimeter of the end ring 1200 and arranged to match with bolt holes 210 and bolt pathways 215 of the valve body 105. The end ring 1200 can define a main cavity 1210 sized to accept the piping element 600. An inner surface 1215 can be the portion of the end ring 1200 that defines the main cavity 1210. The main cavity 1210 can be about circular and define a small cylinder along an axis 1220 of the end ring 1200.

The end ring 1200 can comprise an axially outward end 1225 and an axially inward end 1230. The ends 1225,1230 can be termed as “inward” and “outward” in reference to the gland 1000 when connected to the mechanical joint 200. The axially outward end 1225 can be termed the “front” and the axially inward end 1230 can be termed the “back” for ease of reference. The axially outward end 1225 of the end ring 1200 can be generally flat in the current aspect and can define a front face 1235 of the end ring 1200. In various aspects, additional features such as lugs or guides can be included on front face 1235.

A rear face 1240 of the end ring 1200 can comprise additional features. A retention ring 1250 can protrude from the rear face 1240 in various aspects. In the current aspect, the retention ring 1250 can be annular and thereby cylindrical in general shape. In various aspects, the retention ring 1250 can be of various shapes. The retention ring 1250 can protrude in the axially inward direction and can define the axially inward end 1230 of the end ring 1200. The retention ring 1250 can define a compression surface 1255. The compression surface 1255 can be adjacent to the inner surface 1215. In the current aspect, the compression surface 1255 can be a frustoconical surface sloped to interact with the grip ring 1450 and to assist in compressing the grip ring 1450 into the piping element 600 in assembly. In the current aspect, the compression surface 1255 can be sloped such that an internal diameter of the retention ring 1250 can be largest proximate the axially outward end 1230 of the end ring 1200 and such that the internal diameter of the retention ring 1250 can be smallest distal to the axially outward end 1230 and can blend into the inner surface 1215. In various aspects, various shapes of the compression surface 1255 can be contemplated within the scope of the current disclosure as would be understood by one of skill in the art.

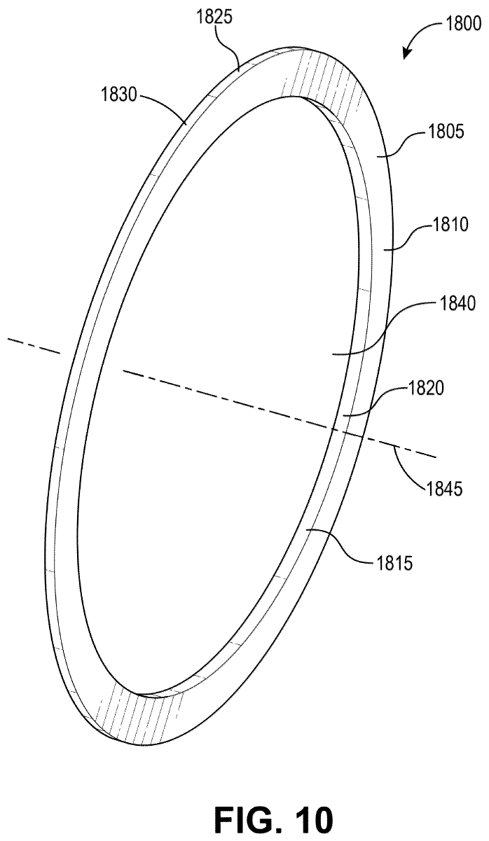

The washer 1800 can be seen in greater detail with reference to FIG. 10. The washer 1800 can be an annular flat washer in various aspects of the current disclosure. The washer 1800 can comprise a pair of opposing flat faces 1805 each defining a contact surface 1810, a radially inner edge 1815 defining an inner surface 1820, and a radially outer edge 1825 defining an outer surface 1830. The radially inner surface 1820 can define a cavity 1840 sized to accept the piping element 600. An axis 1845 of the washer 1800 can be seen for reference.

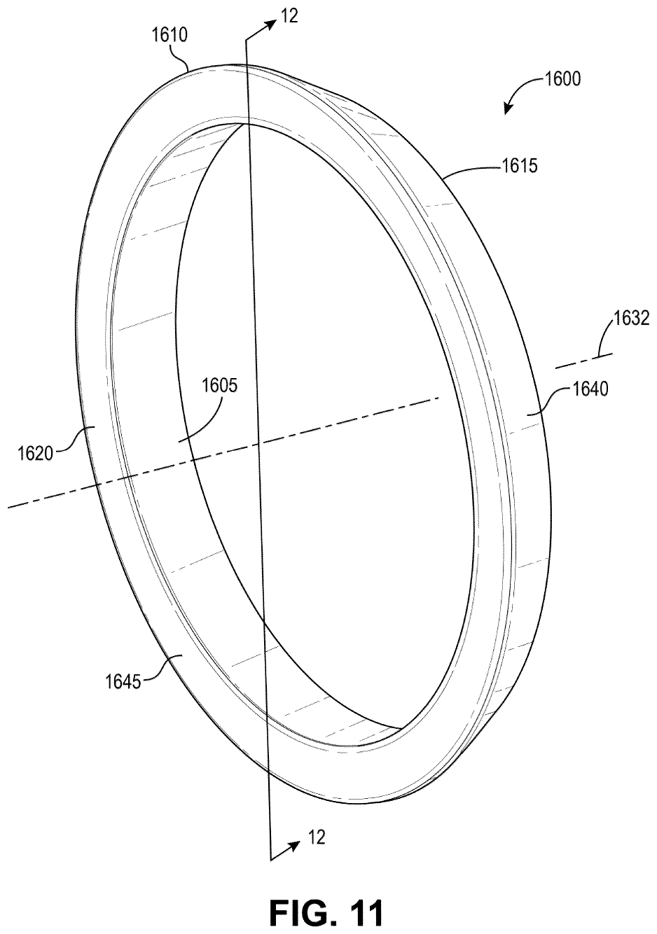

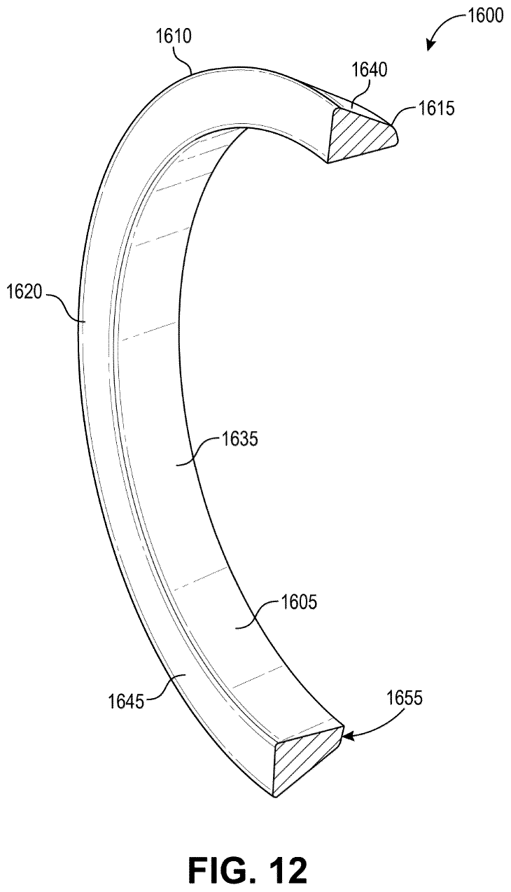

The gasket 1600 can be seen with reference to FIGS. 11-12. The gasket 1600 can comprise a radially inward end 1605, a radially outward end 1610, an axially inward end 1615, and an axially outward end 1620. An axis 1630 of the gasket 1600 can be seen.

The radial ends 1605,1610 can be termed “inward” and “outward” based on the center of the gasket 1600 being coincident with the axis 1630 referenced as being inward. The axial ends 1615,1620 can be termed as “inward” and “outward” in reference to the gland 1000 when connected to the mechanical joint 200. The gasket 1600 can define a radially inner surface 1635 at least partially defining the radially inward end 1605. The radially inner surface 1635 can be configured to interact with the piping element 600 in assembly of the gland 1000. The gasket 1600 can define a radially outer surface 1640 that can at least partially define the radially outward end 1610. The radially outer surface 1640 in the current aspect can be sloped such that the gasket 1600 can be thicker in cross-section proximate the axially outward end 1620 and thinner in cross-section proximate the axially inward end 1615. The sloped radially outer surface 1640 can interact with the gasket chamber 180 in assembly of the gland 1000 with the valve body 105.

The gasket 1600 can be formed of various materials that can allow compression sealing in various aspects. The gasket 1600 can be formed of various materials that can allow deformation sealing in various aspects. In various aspects, the gasket 1600 can be rubber, elastomer, foam, silicone, silicone rubber, neoprene, nitrile rubber, PTFE/Teflon, or various other polymers. In various aspects, the gasket 1600 can be various materials as would be understood to one of skill in the art.

The radially inward end 1605 of the gasket 1600 can be of a smooth texture in various aspects. The radially inward end 1605 of the gasket 1600 can be of a grooved texture in various aspects. The radially inward end 1605 of the gasket 1600 can be of variant texture, such as honeycomb, diamond, or various other patterns. The radially inward end 1605 of the gasket 1600 can be of rough texture in various aspects. All variations of texture can be considered to be within the scope of the disclosure.

The gasket 1600 can define an axially outer surface 1645 and an axially inner surface 1655. The axially outer surface 1645 can at least partially define the axially outward end 1620, and the axially inner surface 1655 can at least partially define the axially inward end 1615.

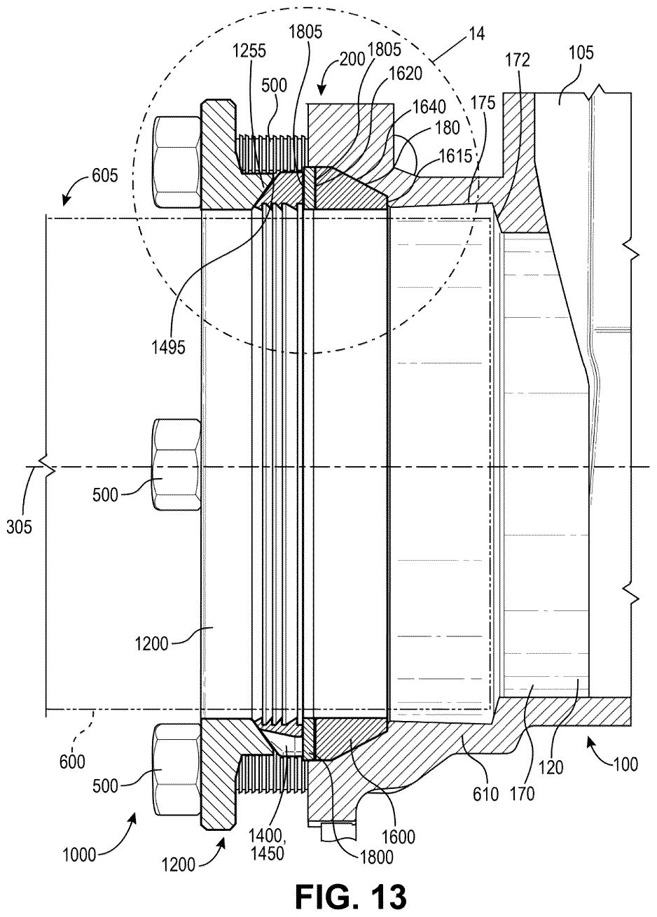

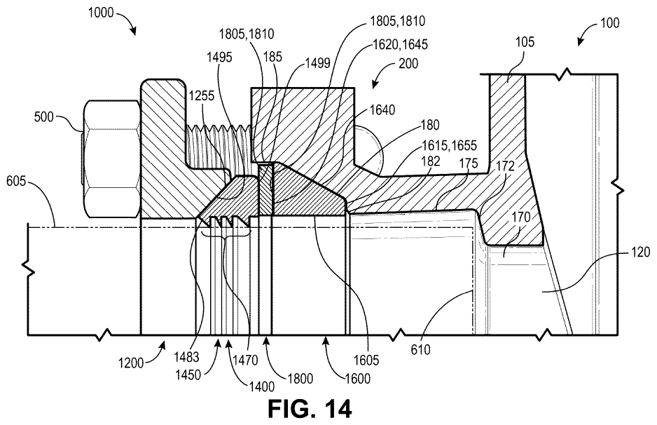

The interaction of the gland 1000 with the valve body 105 can be seen with reference to FIGS. 13-14. The gland 1000 can be seen coupled to the valve body 105 along the mechanical joint 200. Fasteners 500 can be seen contacting the end ring 1200 and the mechanical joint 200. The fasteners 500 can be arranged within the bolt holes 205 and bolt pathways 210 as shown and described previously. In the arrangement shown in the current view, the fasteners 500 can be arranged but not yet tightened. In such an arrangement, the gland 1000 can be termed to be coupled to the mechanical joint 200 in an untightened arrangement. Upon tightening of the fasteners 500, the gland 1000 can become coupled to the mechanical joint 200 in a tightened arrangement. In various aspects, the “untightened” arrangement can be termed a “prepared configuration” or “prepared state.” In various aspects, the “tightened” arrangement can be termed a “completed configuration” or “completed state.” The completed state can also be termed “engaged” or “mechanically engaged.” Various similar terms would be understood by one of skill in the art as referencing the various states shown.

In the untightened arrangement of the gland 1000, the end ring 1200 can be in contact with the gripper 1400, the gripper 1400 can be in contact with the washer 1800, the washer 1800 can be in contact with the gasket 1600, and the gasket 1600 can be in contact with the valve body 105. As the fasteners 500 become tightened, the various parts can be moved in various directions such that the gland 1000 can engage the piping element 600 and such that the gasket 1600 can seal the system to prevent leaking of fluid from within the piping element 600 and the valve 100.

As can be seen, the end ring 1200 can be arranged with the compression surface 1255 in contact with the compression surface 1495 of the grip ring 1450 or gripper 1400. The flat face 1805 of the washer 1800 can be arranged such that the contact surface 1810 can be in contact with the gasket interaction surface 1499 of the grip ring 1450. Another flat face 1805 of the washer 1800 can be arranged in contact with the axially outward end 1620 of the gasket 1600 such that the contact surface 1810 can be in contact with the axially outer surface 1645. The axially inward end 1615 of the gasket 1600 can be arranged such that the axially inner surface 1655 can be in contact with the gasket chamber face 182. Additionally, the radially outer surface 1640 of the gasket 1600 can be in contact with the gasket chamber 180. Such arrangement can allow the radially inner surface 1605 of the gasket 1600 to become in proximity with an outer surface 605 of the piping element 600 and the teeth 1470 of the grip ring 1450 can be in proximity to the outer surface 605 of the piping element 600. The piping element 600 can also define an end 610. In the current aspect, the end 610 can be arranged within the piping chamber 175.

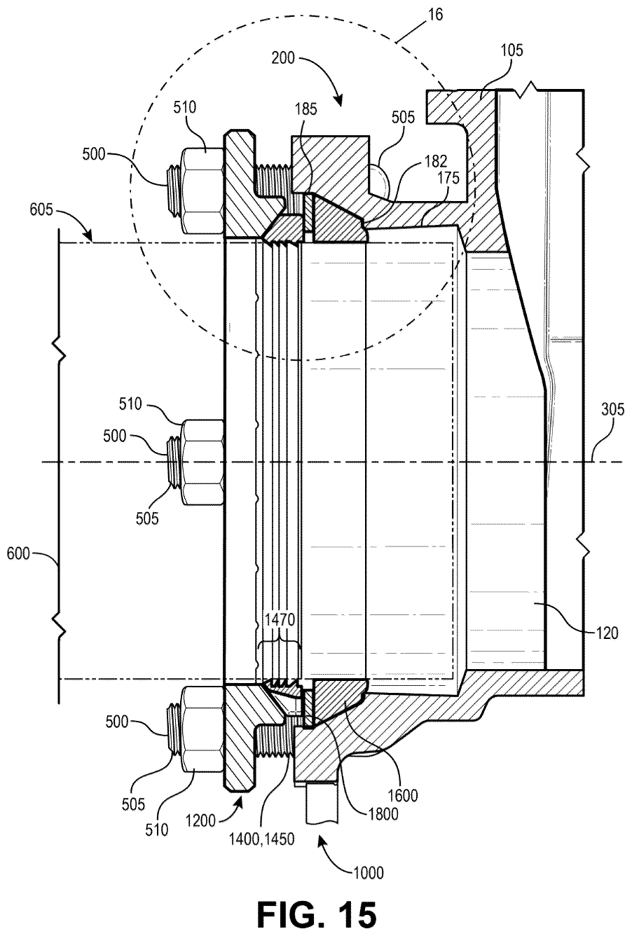

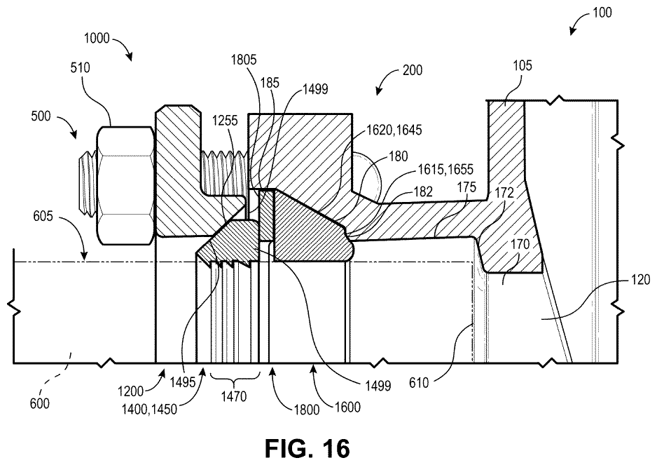

The tightened arrangement can be seen with reference to FIGS. 15-16. As can be seen, the fasteners 500 can be tightened. In various aspects, the fasteners 500 can be tightened by tightening one nut 510 onto each bolt 505. When tightened, the bolt 505 can be seen extending through the nut 510 on the views of FIGS. 15-16. Tightening of the fasteners 500 can draw the end ring 1200 closer to the valve body 105. The compression surface 1255 can the contact compression surface 1495, and the frustoconical shape of both compression surfaces 1255, 1495 interacting with one another can cause the grip ring 1450 to be forced radially inwardly toward the axis 305 as well as axially inwardly toward the valve body 105. As the grip ring 1450 compresses radially inwardly (with returning reference to FIGS. 4-6), the grip ring 1450 can flex along the relief notches, thereby allowing the first body end 1474 to travel toward the second body end 1476 to reduce the gap 1497. Such flexion of the grip ring 1450 can allow the inner diameter 1481 to become reduced until contact with the piping element 600. As seen specifically with the view of FIG. 16, the grip ring 1450 can be in gripping contact with the piping element 600 after the inner diameter 1481 reduces and the gap 1497 reduces. In various aspects, increased body thickness 1489 (seen with reference to FIGS. 4-6) can be needed to prevent the grip ring 1450 from reducing in inner diameter 1481 (seen with reference to FIGS. 4-6) in such a way that the grip ring 1450 can become allowed to escape from the end ring 1200.

The grip ring 1450 can be in contact with the washer 1800 which can be in contact with the gasket 1600, and the gasket 1600 can be in contact with the gasket chamber 180 of the valve body 105. With the gasket 1600 contacting the gasket chamber face 182, the gasket 1600 can be prevented from moving axially inwardly toward the valve body 105. Although the gasket 1600 can compress, the gasket 1600 can also resist axial motion of the washer 1800 and can further restrict axial motion of the grip ring 1450. Such axial resistance can cause tension on the fasteners 500. In the current view, the grip ring 1450 can become biased toward contact with the outer surface 605 of the piping element 600 by interaction of the compression surfaces 1255,1495. The teeth 1470 can grip into and/or bite into the piping element 600. To accomplish such gripping and/or biting engagement, the grip ring 1450 can become deformed along the relief notches 1490, thereby shortening the gap 1497 (seen with reference to FIGS. 4-6). Such gripping of the piping element 600 can thereby allow the piping element 600 to engage with the valve body 105 and can provide mechanical connection between the piping element 600 and the valve body 105 through the various elements of the gland 1000 as described below.

As the fasteners 500 can be tightened and can force the end ring 1200 into the grip ring 1450 and the grip ring 1450 can become biased into the piping element 600, the piping element 600 can become a physical stop to prevent additional radial deformation of the grip ring 1450. Once the grip ring 1450 has reached optimal engagement of the piping element 600 through gripping and/or biting, further tightening of the fasteners 500 can push the grip ring 1450 into the washer 1800 by contact of the gasket interaction surface 1499 of the back 1498 with one flat face 1805. The washer 1800 can become forced inside of the entrance portion 185 of the chamber 120. The washer 1800 can thereby compress the gasket 1600 inside the gasket chamber 180. Because of the sloped arrangement of the frustoconical gasket chamber 180, the gasket 1600 can become compressed toward the piping element 600. The axially outer surface 1645 can contact the gasket chamber 180 thereby forcing the gasket 1600 radially inwardly toward the piping element 600 as the gasket 1600 becomes forced axially inwardly toward the valve body 105. The axially inner surface 1655 of the gasket 1600 can contact the gasket chamber face 182 to prevent the gasket 1600 from traveling axially inwardly into other portions of the chamber 120.

The physical connection of the grip ring 1450 to the piping element 600 can provide a mechanical coupling of the gland 1000 with the piping element 600. The fasteners 500 can be coupled through the end ring 1200 and through the bolt holes 205 and bolt pathways 210 thereby providing a mechanical connection to the between the gland 1000 and the valve body 105. As such, the piping element 600 can be coupled to the valve body 105 by mechanical connection of both of the piping element 600 and the valve body 105 to the gland 1000. Finally, the compression of the gasket 1600 within the chamber 120—and, specifically, within the gasket chamber 180—can cause fluid sealing by the gasket 1600 between the valve body 105 and the outer surface 605 of the piping element 600.

Such an arrangement of elements can allow the gland 1000 to provide mechanical coupling on a wide range of sizes for piping elements. Varying piping materials can have varying specifications for the actual sizes of piping elements despite common sizing nomenclature. For example, although a piping size might be called out as “6 inches,” the actual diameter of such piping element can vary widely. For example, in the case of pipes, a “6 inch” pipe made of steel, stainless steel, or PVC can be 6.625 inches in diameter. In contrast, a “6 inch” pipe made of ductile iron can be 6.9 inches in diameter. Further, a “6 inch” pipe made of copper, CPVC, or PEX can be of 6.125 inches in diameter. As such, the deformable grip ring 1450 and gasket 1600 can allow the gland 1000 to accommodate coupling with varying pipe sizes.

In various aspects, the various elements of the gland 1000 can be assembled onto a valve body 105 in the field. In various aspects, the gland 1000 can be a pre-assembled kit attached to the valve body 105.

As described above, in assembly, the gripper 1400—or, more specifically, the grip ring 1450 in the current aspect—can become mechanically coupled to the piping element 600 by gripping into the piping element 600. As previously described, such gripping can allow the grip ring 1450 to become fully engaged into the piping element 600, at which time the radial deformation of the grip ring 1450 can subside such that further tightening of the fasteners 500 can cause translation of the grip ring 1450 toward the valve body 105. As the piping element 600 travels toward the valve body 105, the end 610 can approach contact with the inner face 172. If such contact occurs before the gasket 1600 is sufficiently compressed to seal the gland 1000, further tightening of the fasteners 500 can cause the teeth 1470 to scrape the outer surface 605 of the piping element 600, which can cause damage to the piping element 600 and potential failure of the gland 1000. It is recommended that the piping element 600 be arranged in the valve body 105 with space between the end 610 and the inner face 172 to allow for some movement of the piping element 600 toward the valve body 105.

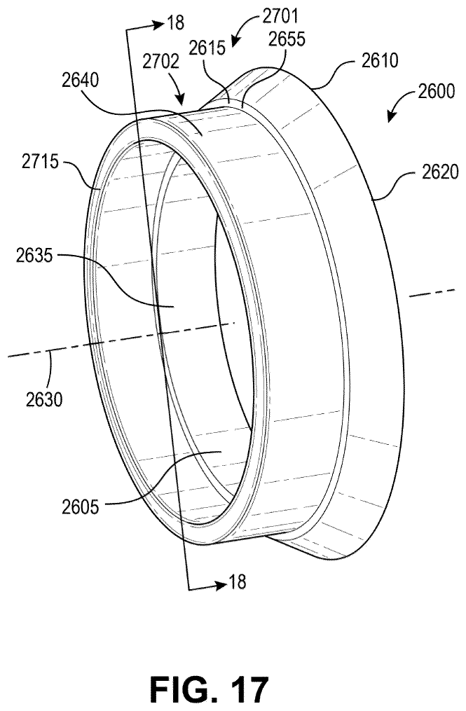

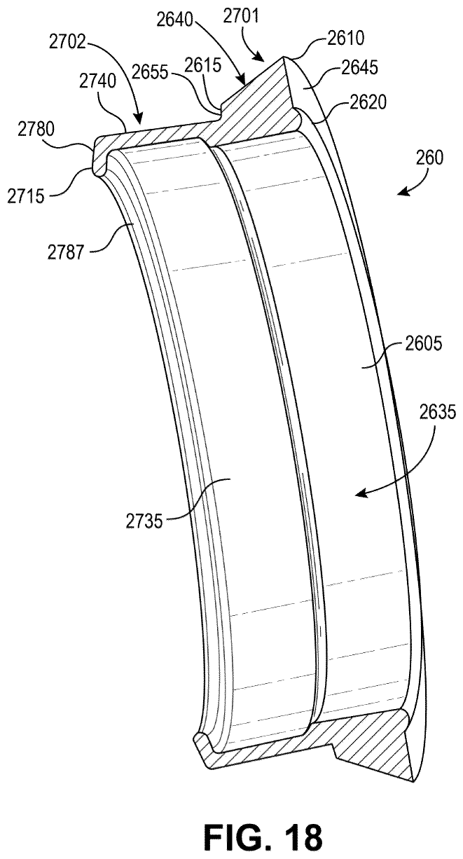

However, to address the potential of the piping element 600 being installed too far into the valve body 105 and risking failure of the gland 1000, a modified gasket 2600 can be seen with reference to FIGS. 17-18. The gasket 2600 can comprise a main portion 2701 and an extended portion 2702. The main portion can be substantially similar to the gasket 1600, thereby comprising a radially inward end 2605, a radially outward end 2610 that can still comprise the radially outward en The gasket 2600 can define an axially outer surface 2645. The main portion 2701 can define an axially inner surface 2655. The axially outer surface 2645 can at least partially define the axially outward end 2620, and the axially inner surface 2655 can at least partially define the axially inward end 2615.

The gasket 2600 can also define the extended portion 2702. The extended portion 2702 can define an axially inward end 2715 of the gasket 2600 in the current aspect. The extended portion 2702 can define a radially inner surface 2735 and a radially outer surface 2740. The radially inner surface 2735 can be cylindrical in shape similar to the radially inner surface 2635 and can be of a slightly larger diameter than the radially inner surface 2635 in the current aspect. As such, the extended portion 2702 can be of a thickness that is relatively thin as compared to other portions of the gasket 2600. The axially inward end 2715 can comprise a lip 2780 extending radially inwardly from the radially inner surface 2735 beyond the radially inner surface 2635 such that a radially inner edge 2787 of the lip 2780 is of a smaller diameter than the radially inner surface 2635. Further, the lip 2780 can be sized such that the radially inner edge 2787 is of a smaller diameter than the outer surface 605 of the piping element 600. In various aspects, the lip 2780 can be sized such that the radially inner edge 2787 is of a smaller diameter than an innermost diameter of the piping element 600. As such, the lip 2787 can be designed to receive the end 610 of the piping element 600 and to prevent the piping element 600 from becoming inserted too far into the valve body 105 prior to tightening of the fasteners 500 in assembling the gland 2000. The gasket 2600 can be formed of a deformable and/or compressible material, so the lip 2787 can be configured to resist misplacement of the piping element 600 as described herein but also can be capable of deforming and/or compressing in response to tightening of the fasteners 500.

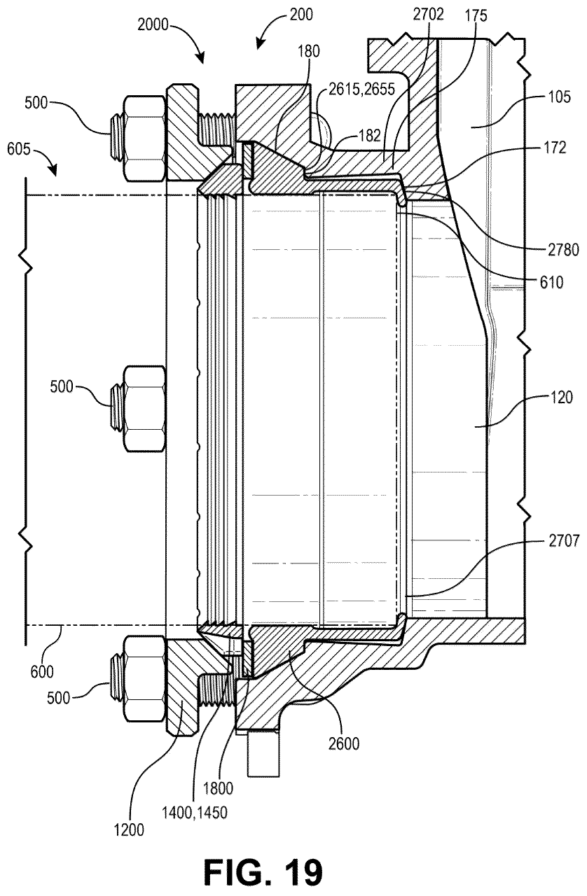

d 2610 of the gasket 2600 in the current aspect, an axially inward end 2615 of the main portion 2701, and an axially outward end 2620 that can still comprise the axially outward end 2020 of the gasket 2600. An axis 2630 of the gasket 2600 can be seen. The radial ends 2605,2610 of the main portion 2701 can be termed “inward” and “outward” based on the center of the gasket 2600 being referenced as being inward. The axial ends 2615,2620 of the main portion 2701 can be termed as “inward” and “outward” in reference to a gland 2000 (seen with reference to FIG. 19) when connected to the mechanical joint 200. The gasket 2600 can define a radially inner surface 2635 at least partially defining the radially inward end 2605 of the main portion 2701. The radially inner surface 2635 can be configured to interact with the piping element 600 in assembly of the gland 2000. The gasket 2600 can define a radially outer surface 2640 that can at least partially define the radially outward end 2610. The radially outer surface 2640 in the current aspect can be sloped such that the gasket 2600 can be thicker in cross-section proximate the axially outward end 2620 and thinner in cross-section proximate the axially inward end 2615. The sloped radially outer surface 2640 can interact with the gasket chamber 180 in assembly of the gland 2000 with the valve body 105.

The gasket 2600 can define an axially outer surface 2645. The main portion 2701 can define an axially inner surface 2655. The axially outer surface 2645 can at least partially define the axially outward end 2620, and the axially inner surface 2655 can at least partially define the axially inward end 2615.

The gasket 2600 can also define the extended portion 2702. The extended portion 2702 can define an axially inward end 2715 of the gasket 2600 in the current aspect. The extended portion 2702 can define a radially inner surface 2735 and a radially outer surface 2740. The radially inner surface 2735 can be cylindrical in shape similar to the radially inner surface 2635 and can be of a slightly larger diameter than the radially inner surface 2635 in the current aspect. As such, the extended portion 2702 can be of a thickness that is relatively thin as compared to other portions of the gasket 2600. The axially inward end 2715 can comprise a lip 2780 extending radially inwardly from the radially inner surface 2735 beyond the radially inner surface 2635 such that a radially inner edge 2787 of the lip 2780 is of a smaller diameter than the radially inner surface 2635. Further, the lip 2780 can be sized such that the radially inner edge 2787 is of a smaller diameter than the outer surface 605 of the piping element 600. As such, the lip 2787 can be designed to receive the end 610 of the piping element 600 and to prevent the piping element 600 from becoming inserted too far into the valve body 105 prior to tightening of the fasteners 500 in assembling the gland 2000. The gasket 2600 can be formed of a deformable and/or compressible material, so the lip 2787 can be configured to resist misplacement of the piping element 600 as described herein but also can be capable of deforming and/or compressing in response to tightening of the fasteners 500.

As can be seen with reference to FIG. 19, the end 610 of the piping element 600 can be separated from the inner face 172 by the lip 2780. The separation of the piping element 600 from the inner face 172 of the valve body 105 can be a gap, a separation, or a spacing in various aspects. The axially inner surface 2655 of the main portion 2701 can contact the gasket chamber face 182 to prevent the main portion 2701 from becoming pushed out of the gasket chamber 180 and into the piping chamber 175. However, the extended portion 2702 can be arranged to fit into the piping chamber 175 by being of relatively thin cross-section. As would be understood by one of skill in the art, tightening of the fasteners 500 as seen in the current view can cause compression forces on the main portion 2701 of the gasket 2600 in the current aspect. Such compression forces can be created as described previously (with reference to gasket 1600 and gland 1000) by compressing the washer 1800 against the gasket 2600 to press the main portion 2701 against the valve body 105 within the gasket chamber 180. Such compression can cause the main portion 2701 of the gasket 2600 to seal against the piping element 600. However, the extended portion 2702 can be exempted from such compression force by its physical arrangement inside the chamber 120—specifically, the arrangement of the extended portion 2702 within the piping chamber 175. As such, the lip 2780 can remain arranged over the end 610 of the piping element 600 even when the main portion 2701 of the gasket 2600 can experience compression forces within assembly of the gland 2000.

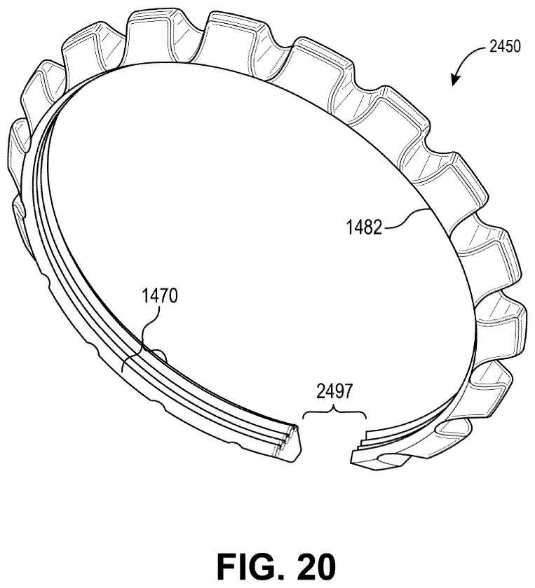

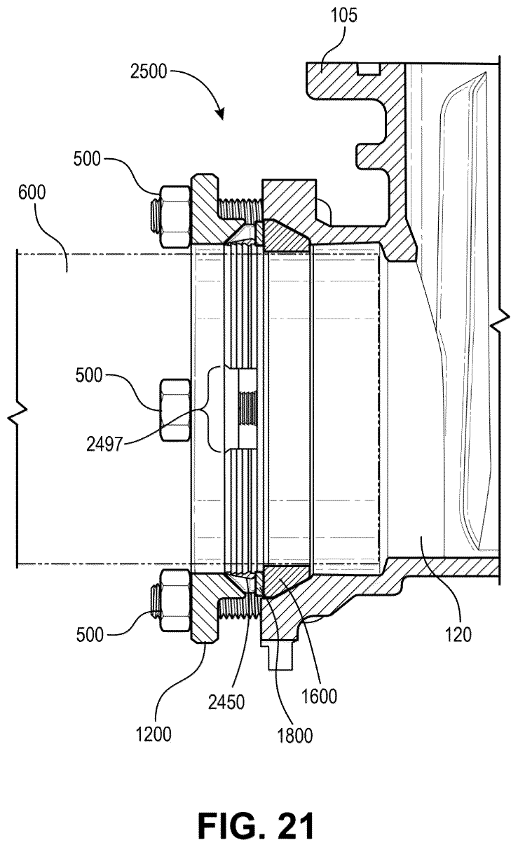

Another aspect of the current disclosure can be seen with reference to FIGS. 20-21. A grip ring 2450 can be substantially similar to grip ring 1450 and can comprise teeth 1470 on radially inward end 1482. The grip ring 2450 can function as the gripper 1400 in the current aspect. The grip ring 2450 can define a gap 2497 that is larger than the gap 1497 of the grip ring 1450. As such, the grip ring 2450 can accommodate a wider range of sizes for the piping element 600 in assembly. The grip ring 2450 can be seen in assembly with a gland 2500 with reference to FIG. 21 specifically. In such aspects as the current one, the washer 1800 can become important to prevent the gasket 1600 from escaping the gland 2500 in the gap 2497. The washer 1800 can provide consistent pressure on the gasket 1600 around its perimeter.

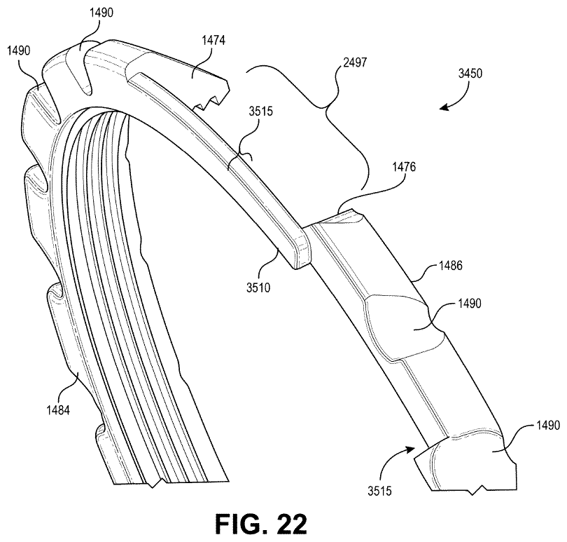

Another aspect of a grip ring 3450 can be seen with reference to FIG. 22. The grip ring 3450 can function as the gripper 1400 in the current aspect. The grip ring 3450 can be substantially similar to grip ring 1450 and grip ring 2450 in various aspects. The grip ring 3450 can comprise the gap 2497 similarly to the grip ring 2450. The grip ring 3450 can comprise a bridge member 3510 that can span the gap 2497 on the axially inward end 1484 of the grip ring 3450. The bridge member 3510 can be of an arcuate shape that about matches the curvature of the remainder of the grip ring 3450. The bridge member 3510 can be about flat in cross-section and can be of a thickness similar to the thickness of the washer 1800. The grip ring 3450 can define an accommodation recess 3515 proximate the second body end 1476. The accommodation recess 3515 can be sized and shaped to accept the bridge member 3510 as the grip ring 3450 deforms in assembly, as described previously. In assembly, the gap 2497 can become smaller as the grip ring 3450 can be subjected to forces from the end ring 1200. The grip ring 3450 can reduce in diameter in response by flexing along the relief notches 1490. As the gap 2497 becomes reduced, the bridge member 3510 can travel into the accommodation recess 3515. Such arrangement can allow the grip ring 3450 to be used in a gland such as gland 2500 without a washer 1800, thereby reducing the number of parts used to assemble such a gland. In various aspects, the bridge member 3510 can be formed with the grip ring 3450. In various aspects, the bridge member 3510 can be connected to the grip ring 3450 by other processes such as welding, fastening, or affixing.

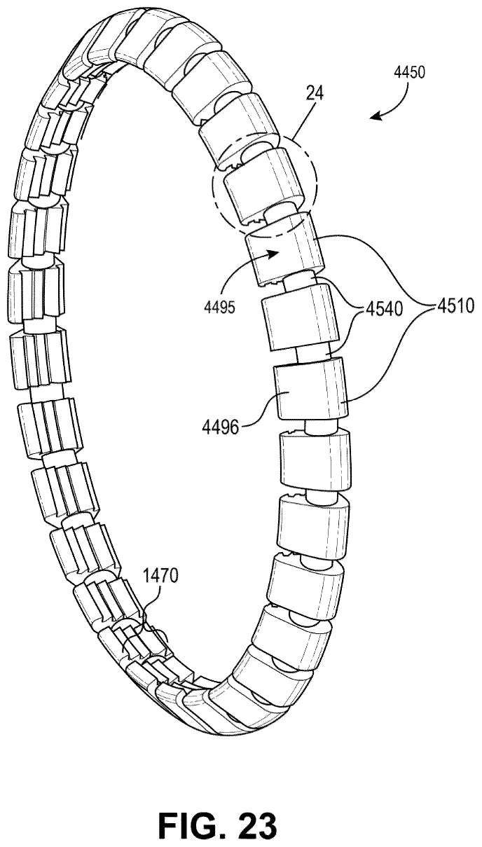

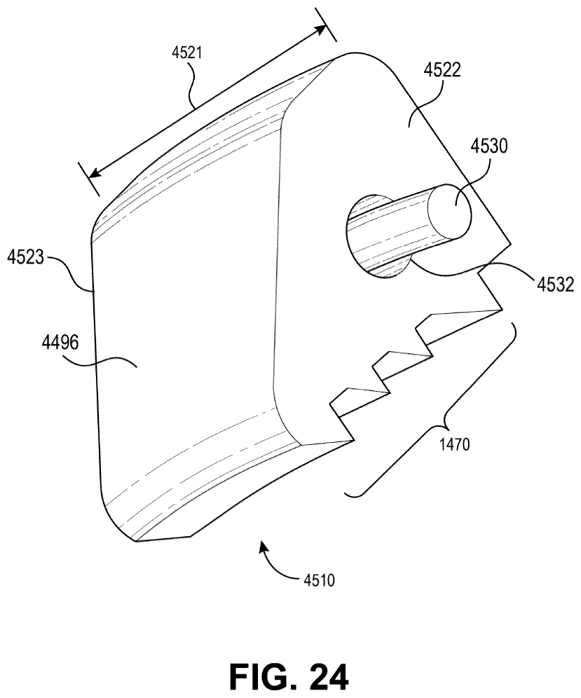

Another aspect of a grip ring 4450 can be seen with reference to FIGS. 23-24. The grip ring 4450 can function as the gripper 1400 in the current aspect. The grip ring 4450 of the current aspect can comprise features similar to other grip rings 1450,2450,2450 previously described in this disclosure. For example, the grip ring 4450 can comprise teeth 1470 similar to those on other grip rings 1450,2450,3450. The grip ring 4450 can comprise a plurality of individual grip segments 4510. Each grip segment 4510 can comprise a plurality of teeth 1470. Each grip segment 4510 can be of a width 4521 as measured from a first circumferential end 4522 to a second circumferential end 4523. In various aspects, each grip segment 4510 can be of the same width 4521. In various aspects, the grip segments 4510 can be of different widths 4521. In some aspects, a large plurality of grip segments 4510 each having small width 4521 can be utilized to form the grip ring 4450. In some aspects, a smaller plurality of grip segments 4510 each having larger widths 4521 can be utilized to form the grip ring 4450. In various aspects, each grip segment 4510 can be about linear. In various aspects—including the aspect shown and described with reference to FIGS. 23-24—each grip segment 4510 can define a radius of curvature.

In the current aspect, each grip segment 4510 can comprise a sloped compression surface 4496 shaped similarly to the sloped compression surface 1495 of various other grip rings 1450,2450,3450. Each grip segment 4510 can define a connection portal 4532. The connection portal 4532 can be a hole extending from the first circumferential end 4522 of the grip segment 4510 to the second circumferential end 4523 of the grip segment 4510.

The plurality of grip segments 4510 can be bound together by a wire 4530. The wire 4530 can be arranged within the connection portal 4532 of each grip segment 4510. The wire 4530 can be a wire suitable for holding the various grip segments 4510 in arrangement. The wire 4530 can be braided steel or similar. In various aspects, the wire 4530 can be a polymeric material. In various aspects, the wire 4530 can be a composite material. In various aspects, the wire 4530 can be formed of a deformable or compressible material.

In aggregate, the sloped compression surfaces 4496 of the individual grip segments 4510 can combine within the assembly of the grip ring 4450 to form a sloped compression surface 4495 of the grip ring 4450. A plurality of spacers 4540 can be located on the wire 4530. In the current aspect, each spacer 4540 can be a rubber washer. In various aspects, various forms of spacers 4540 can be utilized without departing from the scope of the disclosure. The spacers 4540 can be made of a deformable and/or compressible rubber material to allow each grip segment 4510 to be forced closer together when the grip ring 4450 is utilized in assembly.

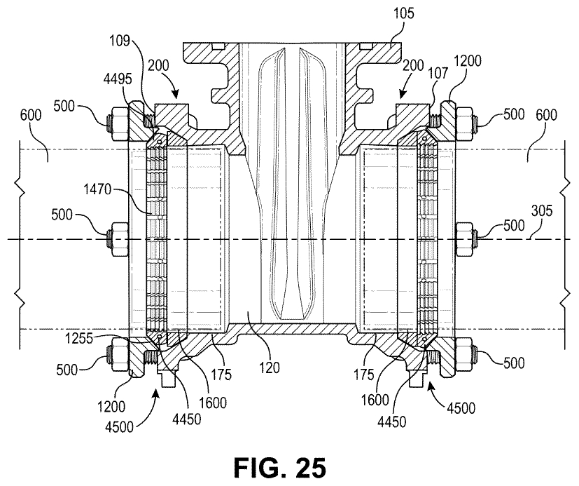

A gland 4500 can be seen coupled to the valve body 105 in two states with reference to FIG. 25. The gland 4500 can be coupled to a first end 107 of the valve body 105 in an untightened arrangement. The gland 4500 can be coupled to a second end 109 of the valve body 105 in a tightened arrangement. As can be seen, the gland 4500 can omit the washer 1800 because the grip ring 4450 in the current aspect can omit a gap such as the gap 1497,2497. In the untightened arrangement as coupled to the first end 107, the piping element 600 can be arranged within the piping chamber 175 with no engagement between the gasket 1600 or the grip ring 4450. In the tightened arrangement as coupled to the second end 109, the end ring 1200 can be pressured into the grip ring 4450 by tightening of the fasteners 500 to draw the end ring 1200 toward the valve body 105. Interaction of the compression surface 1255 with the compression surface 4495 can force the grip segments 4510 both radially inwardly toward the piping element 600 and axially inwardly toward the valve body 105. As the grip segments 4510 move radially inwardly toward the piping element 600, each spacer 4540 can become compressed and/or deformed between adjacent grip segments 4510 as each first circumferential end 4522 of one grip segment 4510 is pressed closer to the second circumferential end 4523 of an adjacent grip segment 4510. The teeth 1470 of each grip segment 4510 can engage the outer surface 605 of the piping element 600. Such engagement can be biting into the outer surface 605. The grip ring 4450 can be forced into the gasket 1600 as described previously with respect to other glands 1000,2000,2500 of the current disclosure.

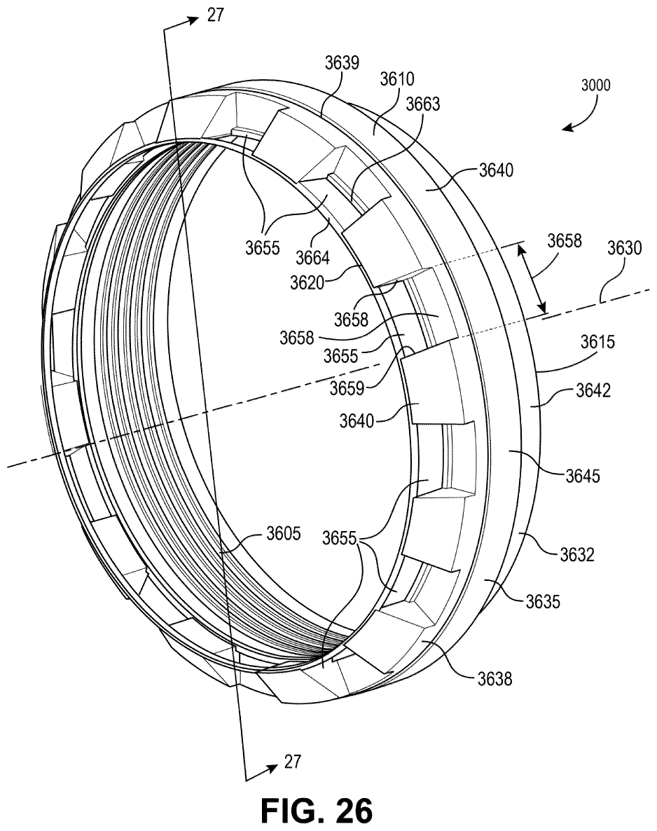

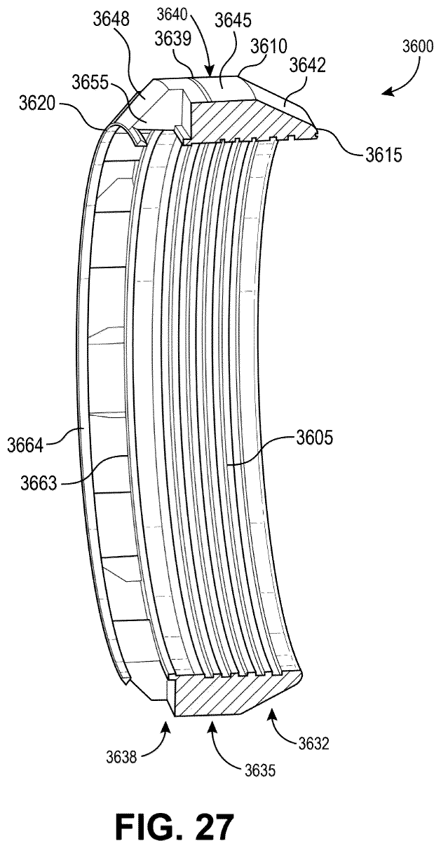

Another aspect of a gasket 3600 can be seen with reference to FIG. 26-27. The gasket 3600 can comprise a structure configured to combine some parts of the various glands 1000,2000,2500,3500. The gasket 3600 can comprise a radially inward end 3605, a radially outward end 3610, an axially inward end 3615, and an axially outward end 3620. An axis 3630 of the gasket 3600 can be seen. The radial ends 3605,3610 can be termed “inward” and “outward” based on the center of the gasket 3600 being coincident with the axis 3630 referenced as being inward. The axial ends 3615,3620 can be termed as “inward” and “outward” in reference connection with the mechanical joint 200. The gasket 3600 can define an inward portion 3632, a central portion 3635, and an outward portion 3638. In various aspects, a groove 3639 can be defined within the gasket 3600 proximate to the transition of the central portion 3635 to the outward portion 3638. As can be seen, the radially inward end 3605 can define a grooved texture in the current aspect. In various aspects, the radially inward end 3605 of the gasket 3600 can be smooth as has been presented with reference to other gaskets (e.g., gasket 1600).

The radially outward end 3610 can define an outer surface 3640 that can comprise an inward surface portion 3642, a central surface portion 3645, and an outward surface portion 3648. The inward surface portion 3642 of the outer surface 3640 can generally comprise a portion of the outer surface 3640 pertaining to the inward portion 3632 of the gasket 3600. Similarly, the central surface portion 3645 of the outer surface 3640 can generally comprise a portion of the outer surface 3640 pertaining to the central portion 3635 of the gasket. Similarly, the outward surface portion 3648 of the outer surface 3640 can generally comprise a portion of the outer surface 3640 pertaining to the outward portion 3638 of the gasket 3600.

Each of the inward portion 3632 and the outward portion 3638 can define frustoconical shapes such that an outer diameter of each of the inward portion 3632 along the inward surface portion 3642 and the outward portion 3638 along the outward surface portion 3648 can be greatest proximate the central surface portion 3645. The outer diameter of the inward surface portion 3642 can be smallest proximate the axially inward end 3615, and the outer diameter of the outward surface portion 3648 can be smallest proximate the axially outward end 3620.

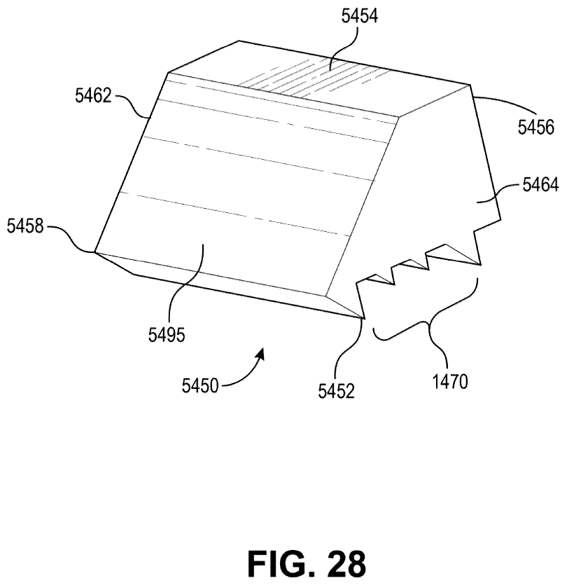

A plurality of grip segment pockets 3655 can be defined within the gasket 3600. Each grip segment pocket 3655 can be defined generally within the outward portion 3638 and can be sized to accept a grip segment 5450 (seen with reference to FIG. 28). In the current aspect, each grip segment pocket 3655 can be of a width 3656 as measured from a first sidewall 3658 to a second sidewall 3659. The first sidewall 3658 and the second sidewall 3659 can be spaced radially by the width 3656 to accommodate the grip segment 5450 (seen with reference to FIG. 28). The grip segment pocket 3655 can define a through-hole for a portion of the grip segment pocket 3655, such that the grip segment pocket 3655 can at least partially penetrate the radially inward end 3605 of the gasket 3600. Such an arrangement can allow portions of the grip segment 5450 (seen with reference to FIG. 28) to protrude through the radially inward end 3605 of the gasket 3600. Each grip segment pocket 3655 can have an axial wall 3661 defining an axially inward end of the grip segment pocket 3655. An axially inward rim 3663 and an axially outward rim 3664 can be located on edges of the grip segment pocket 3655 on the radially inward end 3605 of the gasket 3600 to provide a retention feature for any grip segments 5450 (seen with reference to FIG. 28) located therein.

The grip segment 5450 can be seen with reference to FIG. 28. The grip segment 5450 can comprise a radially inward end 5452, a radially outward end 5454, an axially inward end 5456, and an axially outward end 5458. The grip segment 5450 can comprise a first circumferential end 5462 and a second circumferential end 5464. A sloped compression surface 5495 can transition from the radially outward end 5454 to the axially outward end 5458. The plurality of teeth 1470 can be arranged on the radially inward end 5452. In assembly, each grip segment 5450 can be arranged within the grip segment pocket 3655 with the teeth 1470 arranged between the axially inward rim 3663 and the axially outward rim 3664. The first circumferential end 5462 can be in contact with the first sidewall 3658 and the second circumferential end 5464 can be in contact with the second sidewall 3659. The axially inward end 5456 can be in contact with the axial wall 3661. As such, the grip segment 5450 can become retained within the grip segment pocket 3655. In various aspects, a plurality of grip segments 5450 can be retained within a plurality of grip segment pockets 3655. In various aspects, fasteners or adhesives can be utilized to maintain the grip segment 5450 within the grip segment pocket 3655. In various aspects, additional mechanical retainers can be utilized to maintain the grip segment 5450 within the grip segment pocket. 3655.

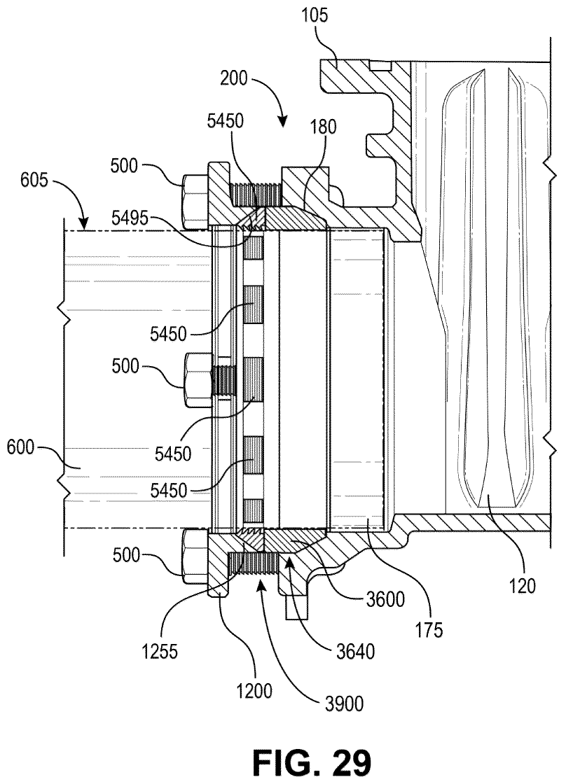

A gland 5000 can be seen with reference to FIG. 29. The gland 5000 can comprise the fasteners 500, the end ring 1200, the gasket 3600, and a plurality of the grip segments 5450. The gasket 3600 combined together with the grip segments 5450 can be termed the gasket assembly 3900. The gasket assembly 3900 can also be termed a “gripper gasket” and can both replace the gasket 1600,2600 and function as the gripper 1400. The gland 5000 can be seen arranged in the coupled and untightened position. With the fasteners 500 untightened, the end ring 1200 can be in contact with the gasket assembly 3900 by contacting the compression surface 1255 against the compression surface 5495. The compression surface 1255 can also contact the outward surface portion 3648 (seen with reference to FIGS. 26-27) of the outer surface 3640 of the gasket 3600. The inward surface portion 3642 of the gasket 3640 can contact the gasket chamber 180 of the valve body 105.

As the fasteners 500 tighten, the contact of the end ring 1200 with the gasket assembly 3900 can cause both gripping action of the grip segments 5450 into the piping element 600 as well as sealing by the gasket 3600 with the outer surface 605 of the piping element 600. As such, the gland 5000 can comprise both mechanical connection between the valve body 105 and the piping element 600 as well as fluid sealing. The gland 5000 can comprise notably fewer parts that other glands 1000,2000,2500,3500,4500 mentioned in this disclosure. As noted previously within this disclosure, various features of the various glands 1000,2000,2500,3500,4500,5000 can be interchanged between the various aspects without departing from the scope of this disclosure.

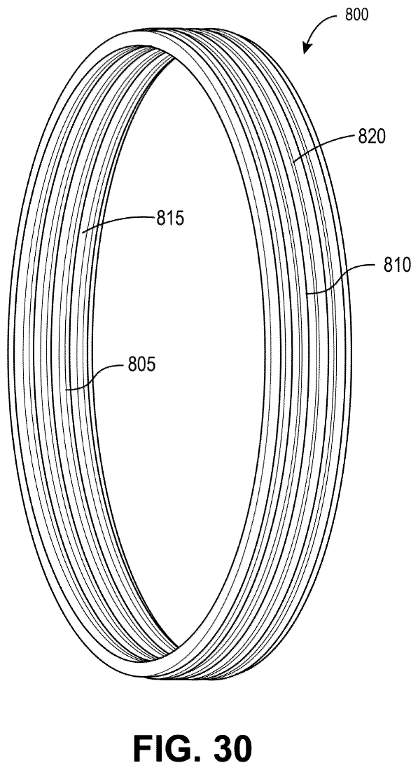

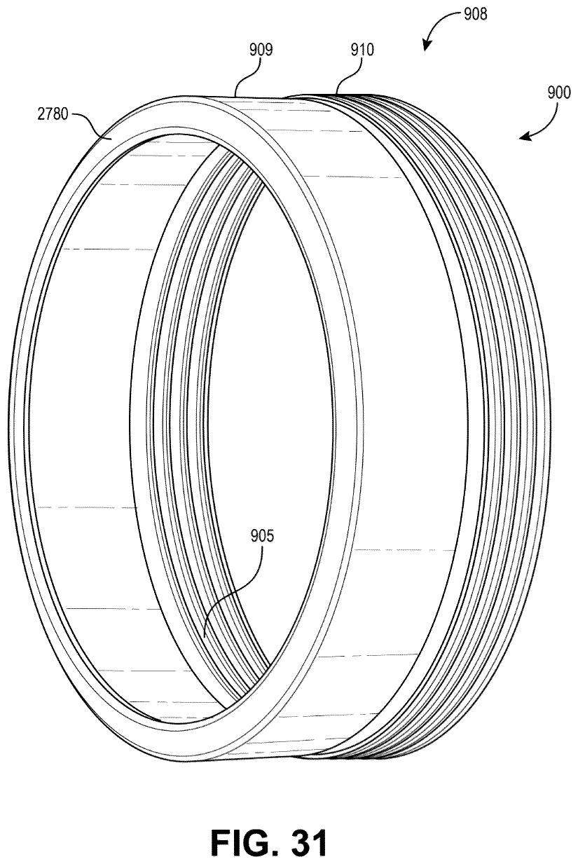

In various aspects, the gaskets 1600,2600,3600 can be modified to be utilized with a tear-out gasket such tear-out gasket 800—disclosed with reference to FIG. 30—and tear-out gasket 900—disclosed with reference to FIG. 31. The tear-out gaskets 800,900 can be utilized as part of a gasket assembly along with variations of the gaskets 1600,2600,3600 previously disclosed. In various aspects, gaskets 1600,2600,3600 can be arranged on top of or interacting with tear-out gaskets 800,900.

With reference to FIG. 30, the tear-out gasket 800 can be an annular gasket of generally cylindrical shape. The tear-out gasket 800 can be of a grooved texture in various aspects. The tear-out gasket 800 can define a radially inner surface 805 and a radially outer surface 810. The radially inner surface 805 can be arranged to accept the piping element 600 and to provide a seal for the outer surface 605. The outer surface 810 can be arranged to interact with one of the previously-disclosed gaskets 1600,2600,3600 or a variation thereof to provide a sealing interface within the various glands 1000,2000,2500,3500,4500,5000. The tear-out gasket 800 can comprise a plurality of grooves 815 defined on the radially inner surface 805 and a plurality of grooves 820 defined on the radially outer surface 810. The grooves 815,820 can be of square or rectangular cross-section in various aspects. In various aspects, the grooves 815,820 can be of various cross-sectional shapes, including (but not limited to) circular, V-shaped, U-shaped, or various other shapes as would be understood by one of skill in the art.

With reference to FIG. 31, the tear-out gasket 900 can be an annular gasket of generally cylindrical shape. The tear-out gasket 900 can comprise a first portion 908 that can be substantially similar to tear-out gasket 800 and can be of a grooved texture in various aspects. The tear-out gasket 900 can also comprise an extended portion 909 that can define a profile substantially similar to the extended portion 2702 of the gasket 2600. The tear-out gasket 900 can also comprise the lip 2780 previously described with reference to gasket 2600.

In various aspects, the tear-out gasket 900 can be arranged on the end 610 of the piping element 600 such that the tear-out gasket 900 can be placed within the piping chamber 175 of the valve body 105 prior to introduction of one of the glands 1000,2000,2500,3500,4500,5000 or a modified version of one of the glands 1000,2000,2500,3500,4500,5000. As such, an outer surface 910 of the tear-out gasket 900 can be arranged to accommodate interaction with one of the gaskets 1600,2600,3600 or a variation thereof, and an inner surface 905 of the tear-out gasket 900 can be arranged to accept the piping element 600 and to provide a sufficient seal against the outer surface 605.

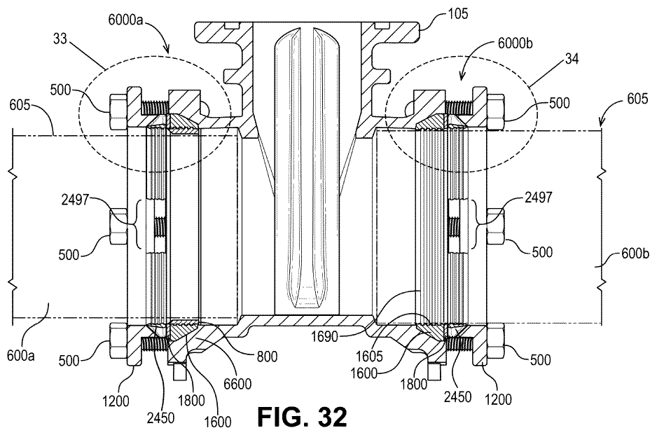

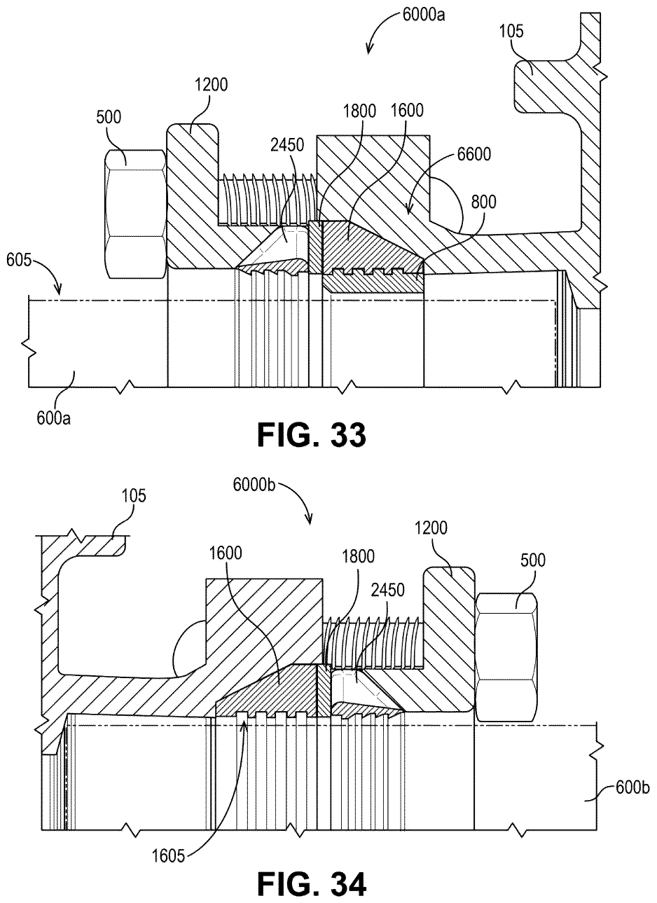

A gland 6000 can be seen with reference to FIGS. 32-34, represented as gland 6000a and gland 6000b. The gland 6000 can comprise many of the parts and features of prior glands 1000,2000,2500,3500,4500,5000 in various arrangements. The gland 6000 of the current aspect can comprise the end ring 1200 coupled to the valve body 105 by the plurality of fasteners 500, as in prior arrangements. In the current aspect, grip ring 2450 can be utilized in contact with the end ring 1200 and the washer 1800. The washer 1800 can be in contact with a gasket assembly 6600 that can comprise the gasket 1600 and the tear-out gasket 800. The gasket 1600 can comprise a plurality of grooves 1690 arranged on the radially inward end 1605. The grooves 1690 can be square grooves defined on the radially inward end 1605. The grooves 1690 can be rectangular grooves in various aspects. The grooves 1690 can be of various cross-sectional shapes, including (but not limited to) circular, V-shaped, U-shaped, or various other shapes as would be understood by one of skill in the art. In the current aspect, the grooves 1690 can be shaped to interact with the grooves 820 of the tear-out gasket 800.

The gland 6000a can represent the gland 6000 of the current aspect arranged on a piping element 600a, and the gland 6000b can represent the same gland 6000 arranged on a piping element 600b. As seen, the piping element 600a can be of a smaller measured diameter than piping element 600b. Nonetheless, the same gland 6000 can be utilized with each piping element 600a,600b, regardless of actual/measured size. As can be seen, the gland 6000b can omit the tear-out gasket 800 that can be included in the gland 6000a. The gland 6000 can be provided with the tear-out gasket 800, and the tear-out gasket 800 can be removed by a user when installing the piping element 600b within the gland 6000 to form the gland 6000b. As the gap 2497 can be large when compared to the gap 1497 of grip ring 1450, the grip ring 2450 can accommodate up to an 8% difference in diameter of the piping element 600. In various aspects, the grip ring 2450 can accommodate even wider differences in diameters. The tear-out gasket 800 can assist in ensuring that the gasket assembly 6600 can be in contact with piping elements 600 with smaller diameters such as piping element 600a, and the tear-out gasket 800 can be removed when the gland 6000 can be used with piping elements 600 with larger diameters such as piping element 600b. As such, the gland 6000 can effectively seal and grip piping elements 600 of varying sizes. In various aspects, the tear-out gasket 800 can be of various sizes to accommodate wider or narrower ranges of diameters from the piping element 600.

In various aspects, the gland 6000 can effectively couple—both mechanically and in fluid seal—the valve body 105 to the piping element 600 across the various sizes of piping elements 600. As mentioned previously, a “6 inch” pipe made of steel, stainless steel, or PVC can be 6.625 inches in diameter; a “6 inch” pipe made of ductile iron can be 6.9 inches in diameter; and, a “6 inch” pipe made of copper, CPVC, or PEX can be of 6.125 inches in diameter. As such, the gland 6000 arranged to accommodate “6 inch” nominal pipe size can accommodate a variance of greater than one inch in measured diameter. Such variance can be up to 17% variance in measured diameter as compared to the nominal pipe size. In various aspects, the gland 6000 can accommodate this wide range of coupling between the large size ductile iron and the small size copper, for example. In various aspects, the gland 6000 can accommodate a smaller but still wide range of pipe size between large ductile iron and the intermediate size steel.

Although the gland 6000 can be described with reference to “6 inch” nominal pipe size, the elements taught and described herein can be applicable to glands 6000 of varying sizes. For example, in various aspects, parts and features of the gland 6000 can be re-sized to any nominal pipe size to accommodate a wide range of actual pipe diameters within such nominal pipe size. For example, a nominal pipe size of 14 inches can be measured at 15.30 inches in ductile iron, 15.65-15.98 inches for cast iron, and nearly 14.0 inches for steel pipe. As such, the gland 6000 arranged to accommodate “14 inch” nominal pipe size can accommodate a variance of almost two inches in measured diameter. Such variance can be up to 15% variance in measured diameter as compared to the nominal pipe size. The gland 6000 can comprise re-sized parts and features to accommodate the larger diameter without departing from the scope of the current disclosure.

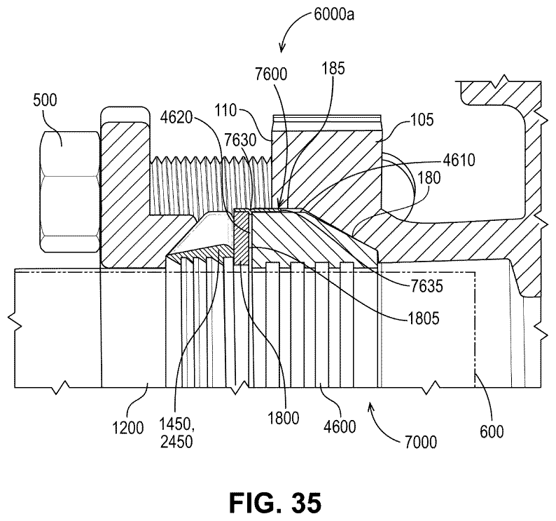

Another aspect of a gland 7000 can be seen with reference to FIG. 35. The gland 7000 can comprise an elongated gasket 4600. The elongated gasket 4600 can be entirely seated within the gasket chamber 180, and portions of the elongated gasket 4600 can extend beyond the first end 110. The elongated gasket 4600 can become compressed and deformed, and the additional material of the elongated gasket 4600 can allow the elongated gasket 4600 to address a wide range of diameters of the piping element 600. When the elongated gasket 4600 can become compressed and/or deformed, the elongated gasket 4600 can connect with a wide range of diameters of piping elements 600 such that the gland 7000 can address multiple pipe sizes. A retention ring 7600 can be seen as a part of the assembly.

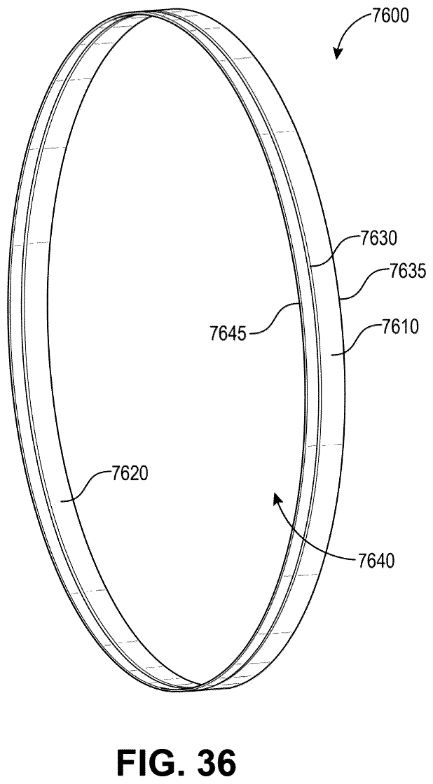

The retention ring 7600 can be seen with reference to FIG. 36. The retention ring 7600 of the current aspect can be an annular ring having an exterior surface 7610 and an interior surface 7620. The retention ring 7600 in various aspects can define a retention feature 7630. The retention feature 7630 can be formed as a groove or depression of the retention ring 7600 toward an interior 7640 of the retention ring 7600. In various aspects, the retention feature 7630 can be various shapes and size and can comprise various features meant to provide a physical stop between a first axial end 7635 of the retention ring 7600 and a second axial end 7645 of the retention ring 7600. In the current aspect, the retention feature 7630 can be annular and can be arranged axially proximate the second axial end 7645.

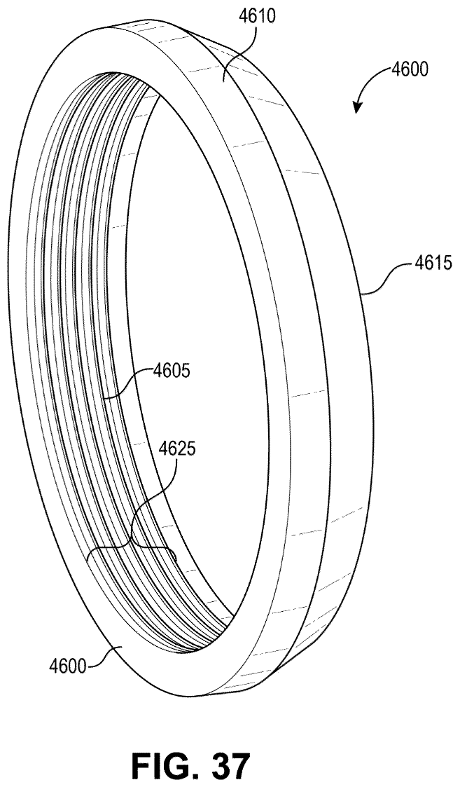

The elongated gasket 4600 can be seen with reference to FIG. 37. The elongated gasket 4600 can define a radially inward end 4605 and a radially outward end 4610. The elongated gasket 4600 can define an axially inward end 4615 and an axially outward end 4620. The radially inward end 4605 can comprise a plurality of grooves 4625 as described elsewhere in this disclosure. It can be seen that the elongated gasket 4600 can comprise a large distance between the axially inward end 4615 and the axially outward end 4620 as compared, for example, to the gasket 1600 with axially inward end 1615 and axially outward end 1620 (seen with reference to FIG. 11). In various aspects, various shapes of the elongated gasket 4600 can be utilized without departing from the scope of the current disclosure.

With reference to FIGS. 35-37, the elongated gasket 4600 in the gland 7000 can, in some aspects, extend beyond the first end 110 of the valve body 105. In various aspects, the elongated gasket 4600 could become pinched between the washer 1800 and the first end 110, thereby reducing the sealing effectiveness of the gland 7000. The retention ring 7600 can be included around the radially outward end 4610 of the gasket 4600 and around the washer 1800 in various aspects. The retention feature 7630 can be arranged between the axially outward end 4620 of the gasket 4600 and the flat face 1805 of the washer 1800. The axially inward end 7635 of the retention ring 7600 can be arranged inside the entrance portion 185 of the valve body 105. As such, the gasket 4600 can be prevented from escaping by the retention ring 7600 and can be directed toward sealing engagement with the piping element 600 by the gasket chamber 180. In the current aspect, the retention ring 7600 can be inserted slightly into the entrance portion 185 such that the retention ring 7600 can be allowed to travel into the entrance portion 185 without contacted the gasket chamber 180 until the other features of the gland 7000 (including the end ring 1200, the grip ring 1450,2450, and the wash 1800) have been allowed to travel toward the gasket 4600 and to compress and/or to deform the gasket 4600.

Various parts, features, elements, or advantages of the various aspects described herein would be interchangeable between the various aspects as would be understood by one of skill in the art. For example, the gasket 2600 can be utilized with the grip ring 4450 in various aspects. The grip ring 4450 could be used with the washer 1800 in various aspects. As mentioned, variations of the gaskets 1600,2600,3600,4600 can be utilized without departing from the scope of the disclosure, including but not limited to introduction of various tear-out gaskets 800,900 or variations thereon. One of skill in the art would readily combine elements of the various features of this disclosure to address specific needs or desires. No single aspect or presentation of the various features described herein should be considered limiting. No single portion of the disclosure should be considered to be encapsulating the scope of the disclosure herein.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A gland for attaching a piping element to a mechanical joint, the gland comprising:
an end ring, the end ring defining a main cavity sized to accept the piping element;
a gripper, the gripper defining a main cavity sized to accept the piping element; the gripper adjacent to the end ring, the gripper comprising a plurality of gripping teeth arranged to contact the piping element;
a gasket arranged around the piping element and configured to receive compressive forces in response to motion of the end ring; and,
at least one fastener connecting the end ring to the mechanical joint in tightening arrangement,
wherein the gasket is in contact with the mechanical joint and with the piping element in arrangement to provide a fluid seal between the mechanical joint and the piping element.

2. The gland of claim 1, wherein the gripper is arranged abutting the end ring.

3. The gland of claim 1, wherein the gasket comprises a main portion and an extended portion, the extended portion being about cylindrical in shape, the extended portion comprising a lip arranged at an end of the extended portion, the lip being arranged to receive the piping element therein.

4. The gland of claim 3, wherein a radially inner edge of the lip is of a smaller dimension than a largest dimension of the piping element.

5. The gland of claim 1, further comprising a tear-out gasket arranged in contact with a radially inward end of the gasket.

6. The gland of claim 5, wherein the tear-out gasket is arranged between the gasket and the piping element.

7. The gland of claim 1, wherein the gasket is an elongated gasket.

8. The gland of claim 7, further comprising a retention ring arranged in contact with a radially outward end of the gasket.

9. The gland of claim 8, wherein the retention ring is arranged between the gasket and the mechanical joint.

10. The gland of claim 1 further comprising a washer arranged between and abutting the gasket and the gripper.

11. The gland of claim 10, wherein the gripper is a grip ring, wherein the grip ring comprises a compression surface, wherein the end ring comprises a compression surface, and wherein the compression surface of the grip ring is in contact with the compression surface of the end ring.

12. The gland of claim 11, wherein at least one compression surface defines a frustoconical shape.

13. The gland of claim 11, wherein the gasket is rubber.

14. The gland of claim 11, wherein the grip ring comprises a first body end and a second body end, wherein the grip ring defines a gap between the first body end and the second body end, wherein the gap can be shortened in response to motion of the end ring toward the grip ring.

15. The gland of claim 14, wherein the grip ring defines a plurality of relief notches configured to allow flexion of the grip ring.

16. The gland of claim 15, wherein the grip ring defines a body thickness as measured radially from a radially inward end of the grip ring to a radially outward end of the grip ring, wherein each relief notch defines a relief notch depth as measured from the radially outward end to a bottom of the relief notch, wherein the relief notch depth is at least 60% of the body thickness.

17. The gland of claim 16, wherein the grip ring is formed of ductile iron.

18. The gland of claim 1, wherein the gripper is a grip ring, wherein the grip ring comprises a compression surface, wherein the end ring comprises a compression surface, and wherein the compression surface of the grip ring is in contact with the compression surface of the end ring, wherein the grip ring comprises a first body end and a second body end, wherein the grip ring defines a gap between the first body end and the second body end, wherein the gap can be shortened in response to motion of the end ring toward the grip ring, wherein the grip ring comprises a bridge member spanning the gap from the first body end to the second body end.

19. The gland of claim 18, wherein the grip ring defines an accommodation recess shaped to accept the bridge member.

20. The gland of claim 1, wherein the gripper comprises a grip ring, the grip ring further comprising:
a plurality of grip segments arranged in a circle, each grip segment defining a connection portal through a width of the grip segment;
a plurality of spacers, each spacer arranged between two grip segments such that each grip segment is spaced from each adjacent grip segment by a spacer and such that each spacer is spaced from each adjacent spacer by a grip segment; and,
a wire arranged within the connection portal of each grip segment.

21. The gland of claim 20, wherein each spacer is rubber and wherein each grip segment is metal.

22. The gland of claim 1, wherein the gasket defines a plurality of grip segment pockets, wherein the gripper comprises a plurality of grip segments, wherein each grip segment is arranged within on grip segment pocket.

23. The gland of claim 22, wherein the end ring contacts each of the plurality of grip segments.

24. A method of connecting a gland to a mechanical joint to secure a piping element within the mechanical joint, the method comprising:
obtaining a gland assembly, the gland assembly comprising
an end ring;
at least one fastener;
at least one gasket; and
at least one gripper, each gripper comprising at least one gripping tooth;
arranging the end ring, the gripper, and the gasket surrounding the piping element, the end ring contacting at least one of the gripper and the gasket, the gripper contacting at least one of the end ring and the gasket;
arranging the piping element within an opening of the mechanical joint;
arranging the at least one fastener in coupling engagement with the end ring and the mechanical joint; and
tightening the at least one fastener such that the at least one gripping tooth contacts the piping element.

25. The method of claim 24, wherein the at least one gripper comprises a grip ring, wherein the grip ring defines a plurality of relief notches, and wherein the step of tightening the at least one fastener such that the at least one gripping tooth contacts the piping element further comprises flexing the grip ring along at least one of the relief notches.

26. The method of claim 24, wherein the at least one gripper comprises a grip ring, wherein the grip ring comprises a first body end and a second body end, wherein the grip ring defines a gap between the first body end and the second body end, and wherein the step of tightening the at least one fastener such that the at least one gripping tooth contacts the piping element further comprises shortening the gap.

27. The method of claim 26, wherein the grip ring defines a plurality of relief notches, and wherein the step of tightening the at least one fastener such that the at least one gripping tooth contacts the piping element further comprises flexing the grip ring along at least one of the relief notches.

28. The method of claim 27, wherein the gland assembly further comprises a washer, further comprising the step of arranging the washer around the piping element between the grip ring and the gasket.

29. The method of claim 24, wherein the at least one gripper comprises a plurality of grip segments.

30. A gripper comprising:
a ring shaped body comprising a first body end and a second body end, the first body end and the second body end being arranged in space to define a gap therebetween, the body defining a radially inward end, a radially outward end, an axially inward end, and an axially outward end;
a gripping surface arranged on the axially inward end;
at least one relief notch formed in the body, each relief notch being defined by at least two segmented body portions that each form portions of the body radially adjacent to the one relief notch; and
each segmented body portion comprising a sloped compression surface proximate the outer radially outward end.

31. The gripper of claim 30, wherein the gripper is formed of ductile iron.

32. The gripper of claim 30, wherein the gripper comprises only one part.

33. The gripper of claim 30, wherein the gripping surface comprises a plurality of gripping teeth formed in the radially inward end.

34. The gripper of claim 30, wherein the sloped compression surface is a frusto-conical surface.

35. The gripper of claim 30, wherein the at least one relief notch comprises a plurality of relief notches.

36. The gripper of claim 30, wherein a thickness of the body can be measured radially from the radially inward end to the radially outward end and wherein a relief notch depth can be measured from the radially outward end to a bottom of each relief notch, wherein the relief notch depth is at least 50% of the body thickness.

37. The gripper of claim 36, wherein the relief notch depth is at least 60% of the body thickness.

38. The gripper of claim 36, wherein the relief notch depth is about 68% of the body thickness.

39. The gripper of claim 30, wherein
a thickness of the body can be measured radially from the radially inward end to the radially outward end;
a relief notch depth can be measured from the radially outward end to a bottom of each relief notch;
a relief thickness can be measured form the radially inward end to the bottom of each relief notch; and,
the relief thickness is less than 0.5 inches.

40. The gripper of claim 39, wherein the relief thickness is less than 0.25 inches.

41. The gripper of claim 39, wherein the relief thickness is less than 0.20 inches.

42. The gripper of claim 39, wherein the relief thickness is about 0.17 inches.

43. A gland comprising:
an end ring;
at least one gripper contacting the end ring, and
at least one gasket contacting the gripper.
